(19) United States
(12) Patent Application Publication
(10) Pub. No.: US 2008/0302890 A1
(43) Pub. Date: Dec. 11, 2008

(54) Garbage Disposer

(76) Inventors: Takahisa Misawa, Tokyo (JP); Masaki Koike, Tokyo (JP)

Correspondence Address: MORGAN LEWIS & BOCKIUS LLP, 1111 PENNSYLVANIA AVENUE NW, WASHINGTON, DC, 20004, US

(21) Appl. No.: 11/631,125

(22) PCT Filed: Jun. 10, 2005
(86) PCT No.: PCT/JP2005/010687

§ 371 Date: Dec. 29, 2006

(30) Foreign Application Priority Data
Jun. 30, 2004 (JP) 2004-194745
Jul. 2, 2004 (JP) 2004-197324

(51) Int. Cl. B02C 23/36

(52) U.S. Cl. 241/46.013

(57) ABSTRACT

A first rotating crushing blade provided at the uppermost stage of crushing blades has one agitation arm. On the agitation arm is formed a press-in surface made by inclining both surfaces of the front and rear, relative to a rotation direction, of the first crushing blade. The press-in surface is a slope where its upper end is inclined in the direction projecting beyond its lower end. In an initial stage of crush, garbage is taken in downward by the press-in surface by rotation operation of the first rotating crushing blade, and a crushing blade in a lower stage can crush the garbage. Alternatively, a crushing unit is constructed from a first rotating crushing blade, a second fixed crushing blade, a third rotating crushing blade, and fourth fixed crushing blade that are layered together and received in a housing. The first rotating crushing blade placed at the uppermost stage of the crushing unit has an integrally formed handle, and the crusher unit is removably attached to a hopper by holding the unit by hand.

### TECHNICAL FIELD

The present invention relates to a garbage disposer for crushing garbage brought about at a kitchen or the like. Particularly, the invention relates to a garbage disposer promoting a performance of taking in the garbage in initially crushing the garbage and promoting operability in cleaning or the like.

### BACKGROUND ART

There are known two kinds of a hammer mill type and a grinder type for garbage disposers for crushing to process garbage of kitchen refuse or the like brought about at general households, restaurants or the like. According to the garbage disposer of the hammer mill type, a fixed hammer or a pivotable hammer is provided above a circular plate arranged at a bottom portion of a hopper in a cylindrical shape (refer to, for example, JP-A-2001-070818 and JP-A-2002-292300).

According to the garbage disposer of the hammer mill type, garbage taken into the hopper is pressed to an inner peripheral face of the hopper by a centrifugal force produced by rotating the circular plate, crushed by the hammer, dropped downward from a gap between an outer edge of the circular plate and a groove formed at a wall face of the hopper or the inner peripheral face of the hopper and is discharged to a discharge pipe.

The garbage disposer of the grinder type is constructed by a constitution in which rotating crush blades and fixed crush blades radially provided with comb-like teeth portions are alternately laminated to be contained in a hopper (refer to, for example, JP-A-2002-521193 and JP-A-2002-524233).

According to the garbage disposer of the grinder type, the respective comb-like teeth portions of the rotating crush blades and the fixed crush blades laminated together are brought in mesh with each other with small gaps therebetweeen, and by rotating the rotating crush blades, garbage is squeezed to be crushed by the comb-like teeth portions of the rotating crush blades and fixed crush blades.

Pitches of blades of the rotating crush blades and the fixed crush blades laminated together become smaller toward lower layers, the garbage taken into the hopper is roughly crushed first by the rotating crush blades and the fixed crush blades at upper layers and further finely crushed by the rotating crush blades and the fixed crush blades at lower layers to be discharged downward.

The garbage disposer of the hammer mil type is designed to operate the circular plate attached to the hammer for crushing garbage at inside of the hopper at high speed of several thousands rpm. Therefore, there poses a problem that in operating the garbage disposer, noise or vibration by impacting to crush garbage to the hammer and the inner peripheral face of the hopper, and sound of rotating the circular plate are large.

On the other hand, according to the garbage disposer of the grinder type constituted by alternately laminating the rotating blades and the fixed blades, it is not necessary to utilize a centrifugal force and therefore, low noise is made to emit by restraining a rotational number.

However, according to the garbage disposer of the grinder type, there poses a problem that comparatively light and considerably bent garbage of a skin of grapefruit, the outer leave of cabbage frequently thrown away as garbage or the like cannot firmly be taken in by the rotating crush blade and the fixed crush blade on the upper stage side.

When garbage cannot be taken in at an initial stage of crushing in this way, there poses a problem that even when crushing operation is carried out for a predetermined time period, garbage remains substantially in an original shape, it is necessary to carry out the crushing operation again, which amounts to prolong a time period of the crushing operation.

Further, according to the garbage disposer of the grinder type, since a plurality of rotating blades and fixed blades are laminated alternately, there poses a problem that when the rotating blades and the fixed blades stay to be integrated at inside of the hopper, cleaning is troublesome and cleaning cannot be carried out sufficiently.

Further, when the fixed blades and the crush blades are contained in a housing to be unitized to be constituted to be attachable and detachable to and from the hopper, a handle for drawing out the housing from the hopper is needed. The handle needs a size easy to be grabbed by the hand in consideration of firm attaching/detaching operability.

However, when the handle is made to be large-sized in consideration of the operability, a space for containing the handle is needed, an influence is effected on a volume of the hopper, and a processable amount of garbage is reduced. Therefore, there poses a problem that it is difficult to provide a handle achieving sufficient operability.

### DISCLOSURE OF THE INVENTION

One or more embodiments of the invention provide a garbage disposer promoting a performance of taking in garbage at an initial stage of crushing.

According to one or more embodiments of the invention, a garbage disposer is provided with a rotating crush blade and a fixed crush blade alternately laminated with each other for crushing garbage by the rotating crush blade and the fixed crush blade by driving to rotate the rotating crush blade so that the garbage is discharged downward. At least a portion of front and rear faces or a front face in a direction of rotating a rotating crush blade of the rotating crush blade or the fixed crush blade arranged at a topmost stage in a direction of laminating the rotating crush blade and the fixed crush blade is inclined to thereby form a push face for pushing downward.

According to one or more embodiments of the invention, a rotating crush blade or a fixed crush blade formed with a push face includes at least one agitating arm extended from a rotational center to an outer periphery, and the agitating arm is formed with the push face.

According to one or more embodiments of the invention, the push face is formed at the rotating crush blade and the rotating crush blade is formed with a handle for adjusting a direction of a direction of rotating the respective rotating crush blades.

Further, one or more embodiments of the invention provide a garbage disposer promoting operability in cleaning or the like.

According to one or more embodiments of the invention provide a garbage disposer for crushing garbage by a rotating crush blade and a fixed crush blade by driving to rotate the rotating crush blade to discharge downward. A crush unit is formed by alternately laminating the rotating crush blade and the fixed crush blade. The crush unit is made to be attachable and detachable to and from a hopper. A handle to be grabbed is formed at the rotating crush blade or the crush blade arranged at the topmost stage of the crush unit.

According to one or more embodiments of the invention, the rotating crush blade is arranged at the topmost stage of the crush unit and a handle is formed at the rotating crush blade at the topmost stage.

According to one or more embodiments of the invention, in the rotating crush blade formed with the handle, the crush blade for crushing an object to be crushed in cooperation with the fixed crush blade arranged at a lower stage thereof is integrally formed with the handle.

Other aspects and advantages of the invention will be apparent from the following description and the appended claims.

### BRIEF DESCRIPTION OF THE DRAWINGS

FIG. 1 is a front sectional view showing an outline of a constitution of a garbage disposer 1 according to one or more embodiments of the invention.

FIG. 2(a) is a plane view of a hopper 3 of the garbage disposer 1.

FIG. 2(b) is a side view of the hopper 3 of the garbage disposer 1.

FIG. 2(c) is a front sectional view of the hopper 3 of the garbage disposer 1.

FIG. 3 is a front sectional view of a crush unit 4 constituting the garbage disposer 1.

FIG. 4 is a disassembled perspective view of an essential portion of the crush unit 4 constituting the garbage disposer 1.

FIG. 5(a) is a plane view of a housing 17.

FIG. 5(b) is a sectional view taken along a line A-A of FIG. 5(a).

FIG. 6(a) is a front view of a first rotating crush blade 12.

FIG. 6(b) is a side view of the first rotating crush blade 12.

FIG. 6(c) is a plane view of the first rotating crush blade 12.

FIG. 7(a) is a plane view of a second fixed crush blade 13.

FIG. 7(b) is a side view of the second fixed crush blade 13.

FIG. 8(a) is a bottom view of a third rotating crush blade 14.

FIG. 8(b) is a sectional view taken along a line B-B of FIG. 8(a).

FIG. 9(a) is a plane view of a fourth fixed rotating crush blade 15.

FIG. 9(b) is a sectional view taken along a line C-C of FIG. 9(a).

FIG. 9(c) is a sectional view taken along a line D-D of FIG. 9(a).

FIG. 10(a) is a plane view of a fifth rotating crush blade 16.

FIG. 10(b) is a sectional view taken along a lien E-E of FIG. 10(a).

FIG. 10(c) is a sectional view enlarging an essential portion of the fifth rotating crush blade 16.

FIG. 11(a) is an operation explanatory view showing take in operation by the first rotating crush blade 12.

FIG. 11(b) is an operation explanatory view showing take in operation by the first rotating crush blade 12.

FIG. 12 is a front sectional view of a crush unit

FIG. 13 is a disassembled perspective view of an essential portion of the crush unit 51.

FIG. 14 is a front sectional view showing an outline of a constitution of a garbage disposer 101 according to one or more embodiments of the invention.

FIG. 15(a) is a plane view of a hopper 103 of the garbage disposer 101.

FIG. 15(b) is a side view of the hopper 103 of the garbage disposer 101.

FIG. 15(c) is a front sectional view of the hopper 103 of the garbage disposer 101.

FIG. 16 is a front sectional view of a crush unit 104 constituting the garbage disposer 101.

FIG. 17 is a disassembled perspective view of an essential portion of the crush unit 104 constituting the garbage processing portion 101.

FIG. 18(a) is a plane view of a housing 116.

FIG. 18(b) is sectional view taken along a line A-A of FIG. 18(a).

FIG. 19(a) is a front view of a first rotating crush blade 112.

FIG. 19(b) is a plane view of the first rotating crush blade 112.

FIG. 19(c) is a sectional view taken along a line B-B of FIG. 19(a).

FIG. 20(a) is a plane view of a second fixed crush blade 113.

FIG. 20(b) is a sectional view taken along a line C-C of FIG. 20(a).

FIG. 20(c) is a bottom view of the second fixed crush blade 113.

FIG. 21(a) is a plane view of a third rotating crush blade 114.

FIG. 21(b) is a sectional view taken along a line D-D of FIG. 21(a).

FIG. 21(c) is a bottom view of the third rotating crush blade 114.

FIG. 22 is a sectional view taken along a line E-E of FIG. 21(a).

FIG. 23(a) is a plane view of a fourth fixed crush blade 115.

FIG. 23(b) is a sectional view taken along a line F-F of FIG. 23(a).

FIG. 23(c) is a sectional view enlarging an essential portion of the fourth fixed crush blade 115.

FIG. 24(a) is a sectional view showing crush/discharge operation by the third rotating crush blade 114 and the fourth fixed crush blade 115.

FIG. 24(b) is a sectional view showing crush/discharge operation by the third rotating crush blade 114 and the fourth fixed crush blade 115.

FIG. 25(a) is a sectional view showing crush/discharge operation by the third rotating crush blade 114 and the fourth fixed crush blade 115.

FIG. 25(b) is a sectional view showing crush/discharge operation by the third rotating crush blade 114 and the fourth fixed crush blade 115.

### DESCRIPTION OF REFERENCE NUMERALS AND SIGNS

1 . . . garbage disposer, 3 . . . hopper, 4 . . . crush unit, 5 . . . speed reducing unit, 5a . . . drive shaft, 6 . . . motor, 7 . . . take in opening portion, 11 . . . lid member, 12 . . . first rotating crush blade, 13 . . . second fixed crush blade, 14 . . . third rotating crush blade, 15 . . . fourth fixed crush blade, 16 . . . fifth rotating crush blade, 17 . . . housing, 20 . . . agitating arm, 21 . . . push in face, 23 . . . arm, 28 . . . arm, 28a . . . comb-like teeth portion, 31 . . . arm, 31a . . . comb-like teeth portion, 39 . . . slit, 101 . . . garbage disposer, 102 . . . base frame, 103 . . . hopper, 104 . . . crush unit, 105 . . . speed reducing gear unit, 105a . . . drive shaft, 106 . . . motor, 107 . . . take in opening portion, 108 . . . discharge pipe connecting port, 109 . . . bottom plate, 110 . . . hole, 111 . . . lid member, 112 . . . first rotating crush blade, 113 . . . second fixed crush blade, 114 . . . third rotating crush blade, 115 . . . fourth fixed crush blade, 116 . . . housing, 117 . . . C ring, 118 . . . crush blade unit, 120 . . . handle, 121 . . . vertical groove, 122 . . . bearing portion, 123 . . . agitating arm, 124 . . . opening portion, 125 . . . shaft attaching hole, 126 . . . fixing hole, 127 . . . hub, 128 . . . arm, 128a . . . comb-like teeth portion, 129 . . . ring, 129a . . . tab, 129b . . . leg portion, 130 . . . hub, 130a . . . first shaft portion, 130b . . . second shaft portion, 131 . . . arm, 131a . . . comb-like teeth portion, 132 . . . ring, 133 . . . push face, 134 . . . wavy face, 135 . . . fixing hole, 136 . . . groove, 137 . . . square hole, 138 . . . hub, 139 . . . slit, 139a . . . stepped portion, 140 . . . hub

### BEST MODE FOR CARRYING OUT THE INVENTION

An explanation will be given of a garbage disposer according to one or more embodiments of the invention in reference to the drawings as follows.

### Embodiment 1

### <Total Constitution of Garbage Disposer>

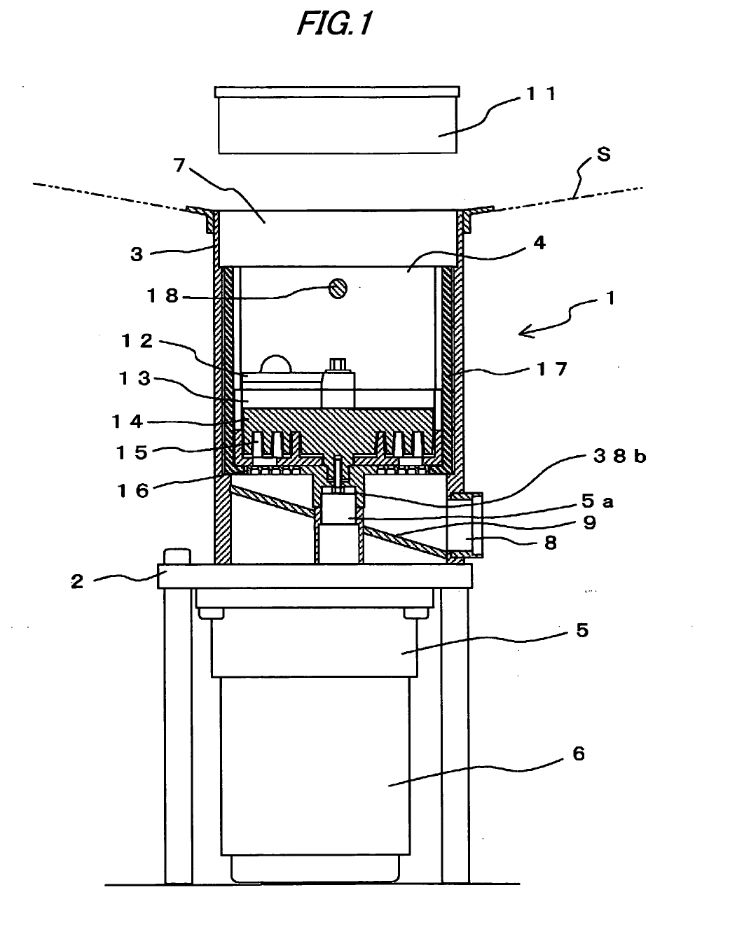

FIG. 1 is a front sectional view showing an outline of a constitution of the garbage disposer 1 according to one or more embodiments of the invention. The garbage disposer 1 is referred to as a grinder type and is installed at, for example, a kitchen facility, the hopper 3 for taking in garbage or the like is mounted to above the base frame 2, and an upper end of the hopper 3 is fitted to an opening portion of a kitchen sink S.

Inside of the hopper 3 is mounted with the crush unit 4 attachably and detachably to and from the hopper 3. In the crush unit 4, a rotating crush blade, mentioned later, is fitted to the drive shaft 5a of the speed reducing unit 5, and the motor 6 attached to the base frame 2 drives to rotate a rotating crush blade of the crush unit 4 by way of the speed reducing unit 5. Although details are not illustrated, a portion of the drive shaft 5a for transmitting a drive force to the crush unit 4 fitted to the crush unit 4 is formed in a shape of a square shaft, a shape of a spline shaft or the like.

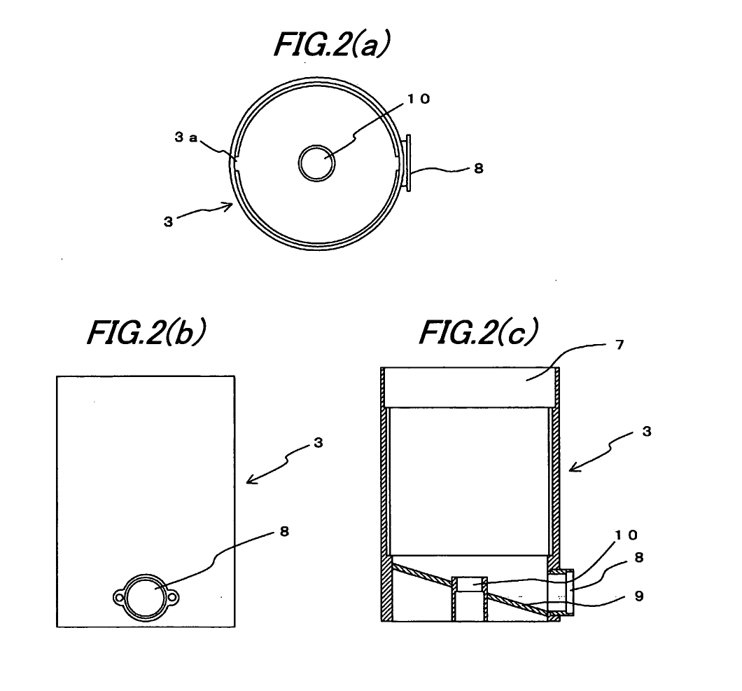

FIG. 2(a) through FIG. 2(c) show the hopper 3 constituting the garbage disposer 1, FIG. 2(a) is a plane view, FIG. 2(b) is a side view, FIG. 2(c) is a front sectional view. The hopper 3 is a part in a shape of an erected cylinder, formed with a groove portion 3a extended in an up and down direction at an inner peripheral face thereof and is formed with the take in opening portion 7 at an upper end thereof. The crush unit 4 shown in FIG. 1 is inserted from the take in opening portion 7 and is made to be attachable and detachable to and from the hopper 3.

Further, a discharge pipe connecting portion 8 is provided at a lower end of a peripheral face of the hopper 3. Further, inside of the hopper 3 is provided with a bottom plate 9 inclined to the discharge pipe connecting portion 8, and a center of the bottom plate 9 is formed with a hole 10 for passing the drive shaft 5a of the speed reducing unit 5 shown in FIG. 1.

The lid member 11 shown in FIG. 1 is attached attachably and detachably to and from the take in opening portion 7 of the hopper 3. The lid member 11 is formed with a water supply hole, not illustrated, to constitute to be able to supply water into the hopper 3 even when the take in opening portion 7 is closed by the lid member 11.

Further, there is provided detecting means for detecting that the take in opening portion 7 is closed by the lid member 11 by utilizing a permanent magnet and a magnet sensor or the like, and control means, not illustrated, controls to drive the motor 6 when it is detected that the take in opening portion 7 is closed by the lid member 11.

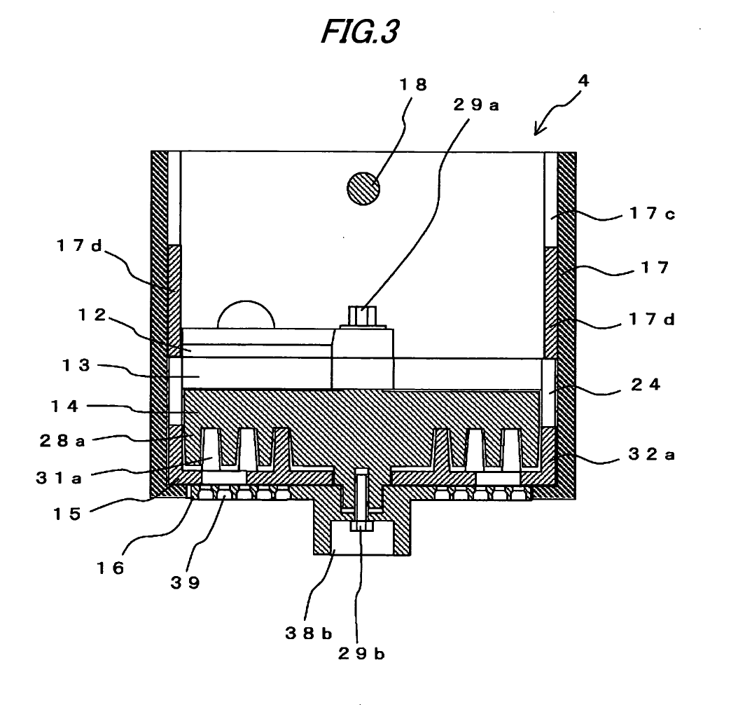

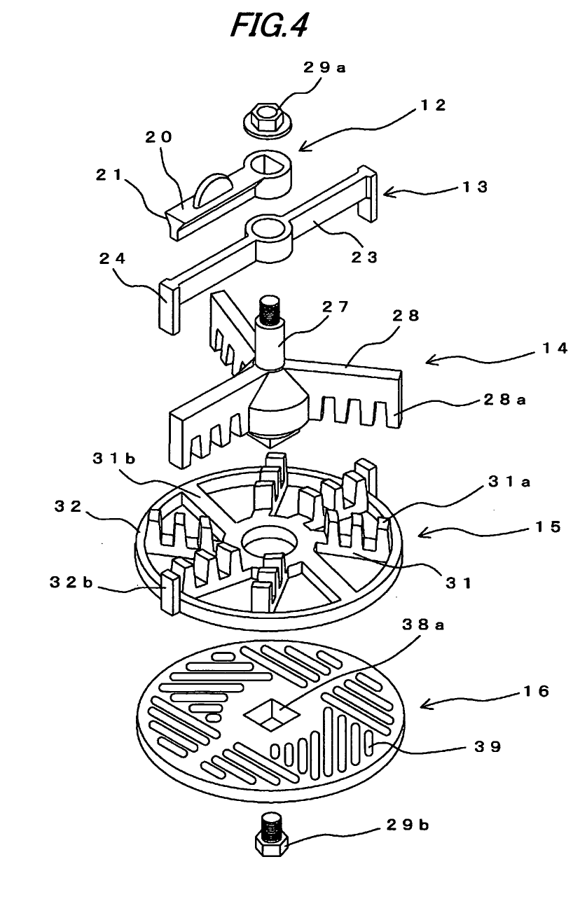

FIG. 3 and FIG. 4 show the crush unit 4 constituting the garbage disposer 1, FIG. 3 is a front sectional view of the crush unit 4, FIG. 4 is a disassembled perspective view of an essential portion of the crush unit 4.

The crush unit 4 is constituted by one unit by containing the first rotating crush blade 12, the second fixed crush blade 13, the third rotating crush blade 14, the fourth fixed crush blade 15 and the fifth rotating crush blade 16 shown in FIG. 4 in the housing 17 as shown by FIG. 3.

The housing 17 is constituted by a cylindrical shape and an outer diameter thereof is constituted to be substantially equal to an inner diameter of the hopper 3 shown in FIG. 2(a) through FIG. 2(c) and the like. The crush unit 4 is inserted from the take in opening portion 7 of the hopper 3, and according to the crush unit 4 mounted to the hopper 3, the housing 17 is held by an inner peripheral face of the hopper 3 to constitute a crush chamber.

Here, the crush unit 4 is made to be attachable and detachable to and from the hopper 3 by holding a handle 18 by providing the handle 18 to the housing 17.

As shown by FIG. 3, dimensions of the first rotating crush blade 12, the second fixed crush blade 13, the third rotating crush blade 14, the fourth fixed crush blade 15 and the fifth rotating crush blade 16 are set to be laminated in a state in which intervals thereamong in an up and down direction are hardly present to thereby prevent crushed garbage from being brought into gaps of the crush blades in the up and down direction to remain at inside of the crush unit 4.

### <Constitution of Crush Unit>

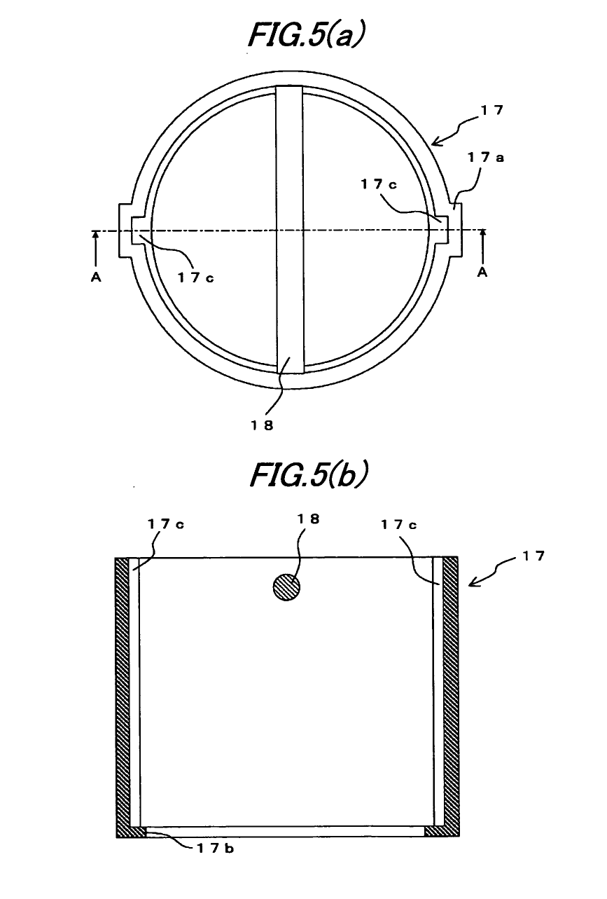

Main constituent parts of the crush unit 4 are shown in FIG. 5(a) through FIG. 10(c). FIG. 5(a) through FIG. 5(b) show the housing 17, FIG. 5(a) is a plane view, FIG. 5(b) is a sectional view taken along a line A-A of FIG. 5(a).

The housing 17 is constituted by a cylindrical shape as described above and is formed with a rib 17a at an outer periphery thereof. According to the housing 17, the rib 17a is fitted to the groove portion 3a of the hopper 3 shown in FIG. 2 and the housing 17 is held at inside of the hopper 3 in a predetermined direction.

Further, the housing 17 is formed with a flange portion 17b at a lower end of an inner peripheral face thereof. As shown by FIG. 3, the respective crush blades are contained in the housing 17 by holding the fourth fixed crush blade 15 at the flange portion 17b as shown by FIG. 3.

Further, the housing 17 is formed with two pieces of vertical grooves 17c at an interval of 180 degrees at the inner peripheral face from an upper end to a lower end thereof as described later, the second fixed crush blade 13 and the fourth fixed crush blade 15 are held at the housing 17 in a state of being unable to be rotated by constituting shapes thereof engaged with the vertical grooves 17c. Further, the handle 18 is attached to an upper end side of the housing 17 by being extended in a diameter direction.

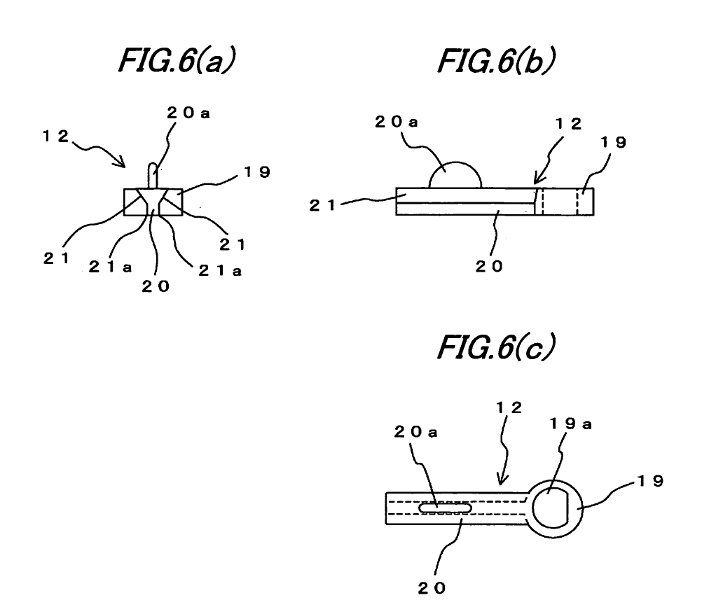

FIG. 6(a) through FIG. 6(c) show the first rotating crush blade 12 arranged at the topmost stage of the crush unit 4, FIG. 6(a) is a front view, FIG. 6(b) is a side view, FIG. 6(c) is a plane view. The first rotating crush blade 12 includes one piece of the agitating arm 20 extended horizontally from a side portion of a bearing portion 19. The first rotating crush blade 12 is formed with the push in faces 21 at two front and rear faces in a direction of rotating the agitating arm 20.

The push in faces 21 are inclined faces (taper faces) inclined in directions of projecting upper ends relative to lower ends at the two side faces of the agitating arm 20. By forming the push in faces 21 at the two side faces of the agitating arm 20, the first rotating crush blade 12 can exert a force of pushing down garbage brought into contact with the push in faces 21 by operation of rotating in two directions. Thereby, the first rotating crush blade 12 takes in garbage by rotating operation to push to the crush blades at lower stages.

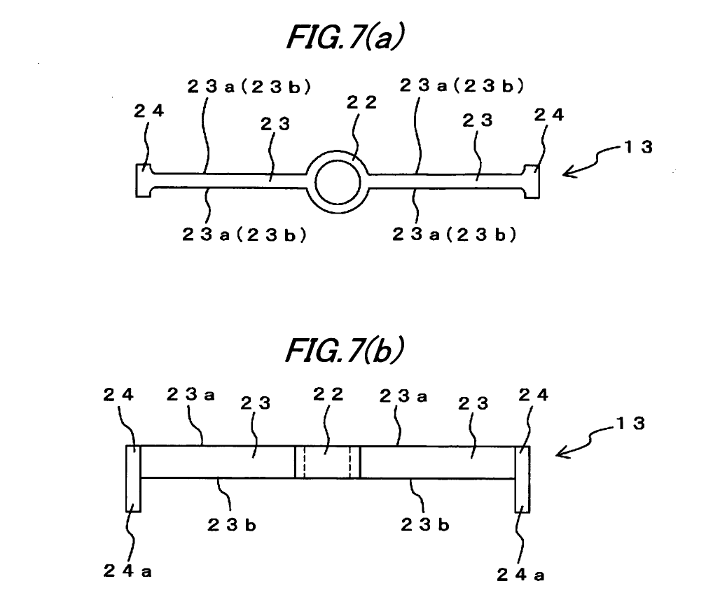

Further, the first rotating crush blade 12 is formed with edges 21a on lower end sides of the two side faces of the push in faces 21 to function as a crush blade for roughly crushing garbage in cooperation with the second fixed crush blade 13 shown in FIG. 7(a) through FIG. 7(b).

Further, the first rotating crush blade 12 is formed with a handle 20a at an upper face of the agitating arm 20. The first rotating crush blade 12 is constituted to rotate integrally with the respective rotating crush blades and therefore, by forming the handle 20a at the first rotating crush blade 12 of the topmost stage, the respective rotating crush blades can be rotated without directly touching the crush blades.

That is, in attaching the crush unit 4 shown in FIG. 3 to the hopper 3 as shown by FIG. 1, in a case of adjusting directions of the respective rotating crush blades for connecting with the drive shaft 5a, when the handle 20a is operated, the directions of the rotating crush blades can be adjusted without directly touching the crush blades.

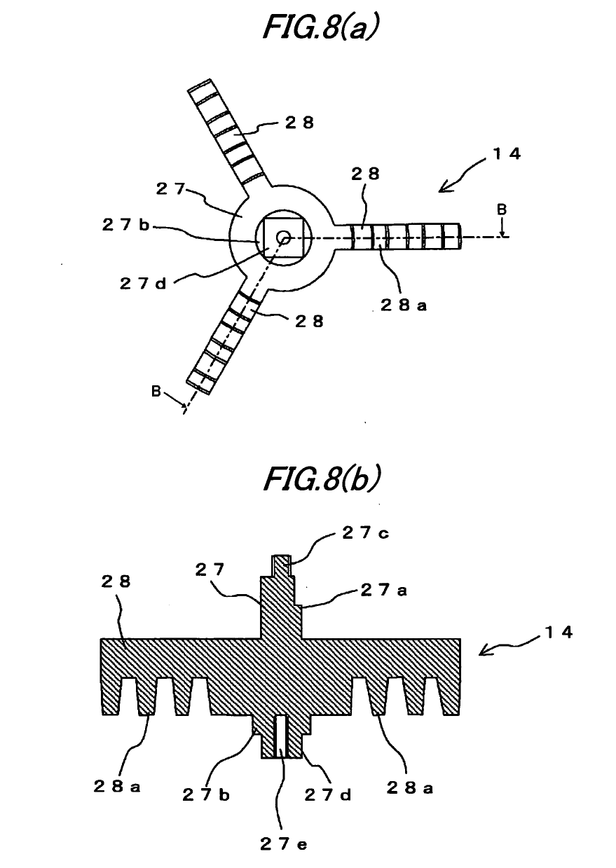

The first rotating crush blade 12 is penetrated to be formed with a shaft attaching hole 19a at the bearing portion 19. The shaft attaching hole 19a is constituted by substantially a D type shape in a sectional shape thereof and is fitted with a shaft portion, mentioned later, of the third rotating crush blade 14 shown in FIG. 8 in a state of being unable to be rotated.

FIG. 7(a) through FIG. 7(b) show the second fixed crush blade 13 arranged at a lower stage of the first rotating crush blade 12, FIG. 7(a) is a plane view, FIG. 7(b) is a side view. The second fixed crush blade 13 includes two pieces of the arms 23 extended horizontally from a hub 22 at an interval of 180 degrees. The respective arms 23 are constituted by a shape of a flat plate, formed with edges 23a, 23b at upper and lower ends of two side faces thereof, and function as crush blades in cooperation with the first rotating crush blade 12 and the third rotating crush blade 13 shown in FIG. 8(a) through FIG. 8(b).

Front ends of the respective arms 23 are formed with tabs 24. The tabs 24 are fitted with the vertical grooves 17c of the housing 17 to restrict rotation of the second fixed crush blade 13. Further, the tab 24 is formed with a leg portion 24a to form a gap having a predetermined height between the second fixed crush blade 13 and the fourth fixed crush blade 15. Further, an inner diameter of the hub 22 is large than a diameter of a shaft portion, mentioned later, of the third rotating crush blade 14 shown in FIG. 8 to constitute a dimension which does not interfere with a shaft portion of the third rotating crush blade 14.

FIG. 8(a) through FIG. 8(b) show the third rotating crush blade 14 arranged at a lower stage of the second fixed crush blade 13, FIG. 8(a) is a bottom view, FIG. 8(b) is a sectional view taken along a line B-B of FIG. 8(a). The third rotating crush blade 14 includes 3 pieces of the arms 28 extended radially from a hub 27 at intervals of 120 degrees. The respective arms 28 are formed with the comb-like teeth portions 28a having a predetermined pitch at bottom faces thereof.

The hub 27 of the third rotating crush blade 14 includes a first shaft portion 27a on an upper side of a face of forming the arm 28 and includes a second shaft portion 27b on a lower side of the face of forming the arm 31. The first shaft portion 27a is rotatably fitted to the hub 22 of the second fixed crush blade 13 shown in FIG. 7(a) through FIG. 7(b). Further, the first shaft portion 27a is constituted by substantially a D type shape in a sectional shape on an upper end side thereof and is fitted to the shaft attaching hole 19a of the first rotating crush blade 12 shown in FIG. 6(a) through FIG. 6(b) to be unable to rotate. Further, a front end of the first shaft portion 27a is formed with a screw portion 27c fastened with a nut 29a shown in FIG. 4.

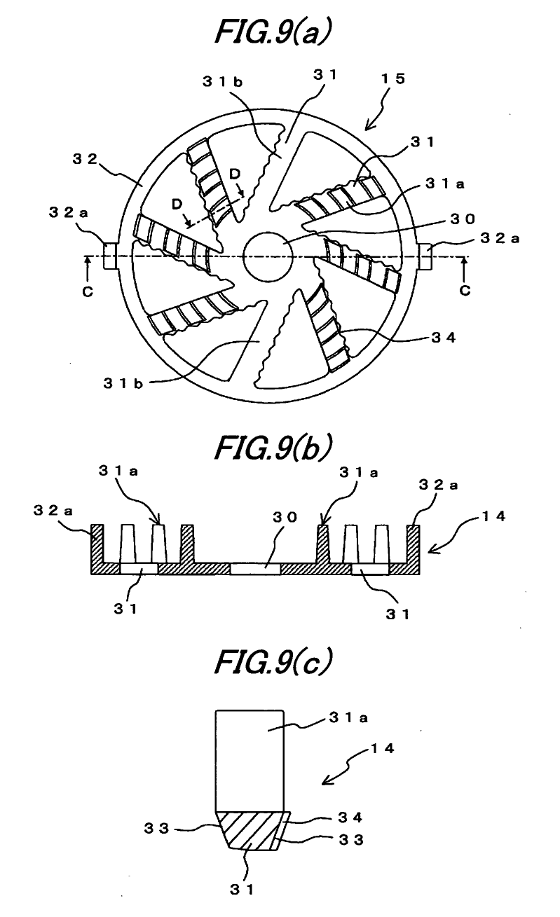

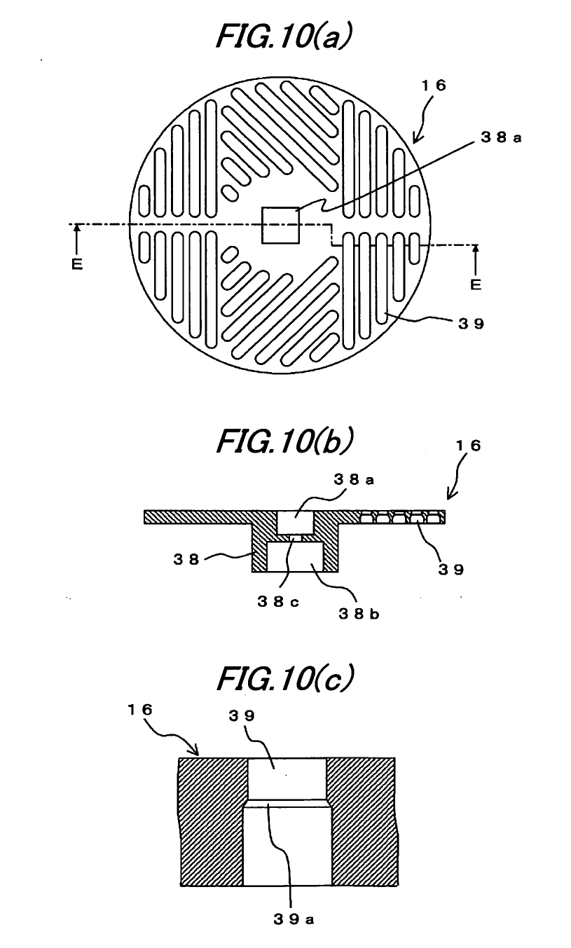

The second shaft portion 27b is rotatably fitted with the fourth fixed crush blade 15 shown in FIG. 9(a) through FIG. 9(c). Further, a lower side of the second shaft portion 27b is formed with a screw shaft portion 27d fitted with the fifth rotating crush blade 16 shown in FIG. 10(a) through FIG. 10(c). Further, a bottom face of the square shaft portion 27d is formed with a screw hole 27e fastened with a screw 29b shown in FIG. 4.

FIG. 9(a) through FIG. 9(c) show the fourth fixed crush blade 15 arranged at a lower stage of the third rotating crush blade 14, FIG. 9(a) is a plane view, FIG. 9(b) is a sectional view taken along a line C-C of FIG. 9(a), FIG. 9(c) is a sectional view taken along a line D-D of FIG. 9(a).

The fourth fixed crush blade 15 is constituted by a shape surrounding 8 pieces of the arms 31 extended radially from a hub 30 in tangential directions at equal intervals by a ring 32. An outer periphery of the ring 32 is formed with tabs 32a projected in radial directions at an interval of 180 degrees. The tabs 32a is fitted to the vertical grooves 17c of the housing 17 to restrict rotation of the fourth fixed crush blade 15.

Further, the tab 32a is provided with a predetermined height and by mounting the leg portion 24a of the second fixed crush blade 13 on an upper face of the tab 32a, a gap having a predetermined height is formed between the second fixed crush blade 13 and the fourth fixed crush blade 15. Further, an inner diameter of the hub 30 is larger than the diameter of the second shaft portion 27b of the third rotating crush blade 14 shown in FIG. 8 to constitute a dimension which does not interfere with the second shaft portion 27b.

The fourth fixed crush blade 15 is formed with the comb-like teeth portions 31a at upper faces of 6 pieces of the arms 31 in 8 pieces of the arms 31. The comb-like teeth portions 31a of the fourth fixed crush blade 15 are provided with a pitch brought in mesh with the comb-like teeth portions 28a of the third rotating crush blade 14 shown in FIG. 8(a) through FIG. 8(c), and as shown by FIG. 3, when the third rotating crush blade 14 and the fourth fixed crush blade 15 are laminated, there is brought about a state of bringing the comb-like teeth portions 28a, 31a of the both members in mesh with each other to form slight gaps therebetween.

Thereby, the comb-like teeth portions 31a of the fourth fixed crush blade 15 crush garbage carried from the crush blades of the upper stages in cooperation with the comb-like teeth portions 28a of the third rotating crush blade 14.

As described above, there are 3 pieces of the arms 28 of the third rotating crush blade 14 and 8 pieces of the arm 31 of the fourth fixed crush blade 15 and therefore, an interval between the arms 31 is narrower than an interval between the arms 28.

Therefore, when the comb-like teeth portions 31a are provided for all of 8 pieces of the arms 31, there is brought about a state in which the comb-like teeth portion 31a of the fourth fixed crush blade 15 is always present between the arms 28 of the third rotating crush blade 14, there is brought about a phenomenon in which when garbage of a block shape having a some degree of size is taken in, garbage is not brought into between the arms 28 of the third rotating crush blade 14 to be made to be difficult to be crushed.

Hence, in the fourth fixed crush blade 15, by not providing the comb-like teeth portions 31a at, for example, 2 pieces of arms 31b in 8 pieces of the arms 31, in operating to rotate the third rotating crush blade 14, when the arm 31 which is not provided with the comb-like teeth portion 31a of the fourth fixed crush blade 15 is disposed between the arms 28 of the third rotating crush blade 14, a wide space is formed in a circumferential direction.

Thereby, even when garbage in the block shape having some degree of the size is taken in, garbage is brought to between the arms 28 of the third rotating crush blade 14 and garbage is crushed by operating to rotate the third rotating crush blade 14 in cooperation with the comb-like teeth portion 28a and the comb-like teeth portion 31a of the other arm 31 of the fourth fixed crush blade 15.

Further, when a number of the arms 31 which are not provided with the comb-like teeth portions 31a in the fourth fixed crush blade 15 is large, crush function is reduced and therefore, when, for example, 8 pieces of the arms 31 are provided, it is preferable to provide about 2 pieces of the arms 31b which are not provided with the comb-like teeth portions 31a.

Further, the respective arms 31 restrain a peak of a crush load and flatten the load by shifting a point of being brought in mesh with the fourth fixed crush blade 15 in the circumferential direction when the third rotating crush blade 14 is rotated by being extended radially along a tangential directions of the hub 30.

As shown by FIG. 9(c), the fourth fixed crush blade 15 is formed with push faces 33 at two front and rear faces of the respective arms 31 and the push faces 33 are inclined faces (taper faces) inclined in directions of projecting upper ends relative to lower ends at the two side faces of the arm 31.

The fifth rotating crush blade 16 shown in FIG. 10(a) through FIG. 10(c) is operated to rotate while rubbing with the bottom faces of the arms 31 of the fourth fixed crush blade 15, by forming the push faces 33 at the both side faces of the arms 31, a force of pushing garbage (crushed to some degree of size) brought into contact with the push face 33 to the fifth rotating crush blade 16 by operating to rotate the fifth rotating crush blade 16.

A wavy face 34 aligned with vertical grooves is formed at one side face of each arm 31. Thereby, in operating to rotate the fifth rotating crush blade 16 shown in FIG. 10(a) through FIG. 10(c) in one direction, garbage is caught by recess portions of the wavy faces 34 to retrain garbage from moving in a radius direction, and garbage is made to be able to be crushed firmly.

FIG. 10(a) through FIG. 10(c) show the fifth rotating crush blade 16 arranged at a lower stage of the fourth fixed crush blade 15, FIG. 10(a) is a plane view, FIG. 10(b) is a sectional view taken along a line E-E of FIG. 10(a), FIG. 10(c) is sectional view enlarging an essential portion.

The fifth rotating crush blade 16 is constituted by a shape of a circular plate and is aligned with a number of slits 39 at an entire face thereof except a hub 38 at a center. Further, the fifth rotating crush blade 16 of the example is formed with a plurality of slit groups and in each slit group, the slits 39 contiguous to each other are aligned substantially in parallel.

An upper face of the fifth rotating crush blade 16 is constituted by a plane which is rotated while being brought into contact with the bottom faces of the respective arms 31 of the fourth fixed crush blade 15 shown in FIG. 9(a) through FIG. 9(c). Further, the slit 39 shown in FIG. 10(a) through FIG. 10(c) is penetrated from head to tail of the fifth rotating crush blade 16 and sharp edge is formed at an edge portion of an opening on the upper face side of the slit 39.

Garbage crushed by the comb-like teeth portions 28a of the third rotating crush blade 14 shown in FIG. 8(a) through FIG. 8(b) and the comb-like teeth portions 31a of the fourth fixed crush blade 15 shown in FIG. 9(a) through FIG. 9(c) and dropped to the upper face of the fifth rotating crush blade 16 is caught by the slit 39, pushed to the slit 39 by the push face 33 of the fourth fixed crush blade 15 by rotating the fifth rotating crush blade 16 and is crushed by the edge portion of the slit 39. Further, finely crushed garbage is dropped downward by passing the slit 39, passes the bottom plate 9 of the hopper 3 shown in FIG. 2 and is discharged to outside from the discharge pipe connecting port 8.

Now, as shown by FIG. 10(c), the slit 39 is formed with a stepped portion 39a, an opening on a bottom face side is made to be larger than an opening on an upper face side and garbage pushed into the slit 39 is facilitated to drop. Thereby, garbage pushed into the slit 39 by the push face 33 of the fourth fixed crush blade 15 is facilitated to drop downward.

The hub 38 of the fifth rotating crush blade 16 is formed with a square hole portion 38a fitted with the square shaft portion 27d of the third rotating crush blade 14 shown in FIG. 8(a) through FIG. 8(c) on the upper face side. Further, the bottom face side of the hub 38 is formed with a square hole portion 38b fitted with the drive shaft 5a shown in FIG. 1. Further, a through hole 38c for passing a screw 29b shown in FIG. 4 is formed between the square hole portion 38a and the square hole portion 38b.

Next, an explanation will be given of a state of integrating the respective crush blades in reference to FIG. 3 through FIG. 10(c). The second shaft portion 27b of the third rotating crush blade 14 is rotatably fitted with the hub 30 of the fourth fixed crush blade 15, and the square shaft portion 27d of the second shaft portion 27b is fitted to the square hole portion 38a of the fifth crush blade 16.

Further, the screw 29b is fastened to the screw hole 27e of the screw shaft portion 27d from the side of the square hole portion 38b of the fifth rotating crush blade 16, and the third rotating crush blade 14 and the fifth rotating crush blade 16 are integrally constituted.

Further, the first shaft portion 27a of the third rotating crush blade 14 is rotatably fitted with the hub 22 of the second fixed crush blade 13, further, the first shaft portion 27a is unrotatably fitted with the shaft attaching hole 19a of the first rotating crush blade 12.

Further, the screw portion 27c of the first shaft portion 27a is fastened with the nut 29a, the first rotating crush blade 12 and the third rotating crush blade 14 are integrally constituted, and the first rotating crush blade 12, the third rotating crush blade 14 and the fifth rotating crush blade 16 are integrated in a mode of squeezing the second fixed crush blade 13 and the fourth fixed crush blade 15.

Further, the respective crush blades integrated as described above are attached to the housing 17 by fitting the tab 24 of the second fixed crush blade 13 and the tab 32a of the fourth crush blade 15 to the vertical groove 17c of the housing 17 to thereby hold the second fixed crush blade 13 and the fourth fixed crush blade 15 unrotatably by the housing 17.

Further, by fitting a holding metal piece 17d to the vertical groove 17c to be fixed by a screw or the like, not illustrated, the respective crush blades are held to be unable to move in the up and down direction by the holding metal piece 17d and the flange portion 17b. Thereby, the first rotating crush blade 12, the third rotating crush blade 14 and the fifth rotating crush blade 16 are made to be rotatable relative to the housing 17.

### <Operation of Garbage Disposer>

Next, operation of the garbage disposer 1 shown in FIG. 1 will be explained. First, explaining operation of a total of the garbage disposer 1 in reference to the respective drawings, when garbage is taken in from the take in opening portion 7 and the take in opening portion 7 is closed by the lid member 11, for example, control means, not illustrated, detects that the taken in opening portion 7 is closed by the lid member 11 and rotates the motor 6. Specifically, rotating operation of repeating regular rotating and inverse rotating operation is carried out at every several seconds, for example, at every 5 seconds. A rotational speed of the motor 6 is set to about 100 rpm to restrain noise or vibration from being brought about.

Further, the lid member 11 is formed with a water supply hole, not illustrated, to construct a constitution capable of supplying water into the hopper 3 even when the take in opening portion 7 is closed by the lid member 11 and in processing to crush garbage, water is supplied to inside of the hopper 3 by making water flow at the sink S.

When the motor 6 is rotated, in the crush unit 4, the first rotating crush blade 12 and the third rotating crush blade 14 and the fifth rotating crush blade 16 are rotated integrally. In contrast thereto, the second fixed crush blade 13 and the fourth fixed crush blade 15 are not rotated.

Thereby, garbage taken into the hopper 3 from the take in opening portion 7 is agitated by the agitating arm 20 of the first rotating crush blade 12 and grossly crushed in cooperation with the arm 23 of the second fixed crush blade 13 at the lower stage and crushed garbage is brought to between the arms 28 of the third rotating crush blade 14.

Garbage brought to between the arms 28 of the third rotating crush blade 14 is finely crushed by bringing the comb-like teeth portion 28a of the arm 28 and the comb-like teeth portion 31a of the arm 31 of the fourth fixed crush blade 15 at the lower stage in mesh with each other by rotating the third rotating crush blade 14.

Here, according to the fourth fixed crush blade 15, by providing the arm 31b which is not provided with the comb-like teeth portion 31a in the plurality of arms 31, when the arm 31b which is not provided with the comb-like teeth portion 31a is disposed between the arms 28 of the third rotating crush blade 14 by rotating the third rotating crush blade 14, a large space is formed in the circumferential direction. Thereby, even large garbage of a block shape or the like is brought to between the arms 28 of the third rotating crush blade 14 and is finely crushed by bringing the comb-like teeth portion 28a of the third rotating crush blade 14 and the comb-like teeth portion 31a of the other arm 31 of the fourth fixed crush blade 15 in mesh with each other by rotating the third rotating crush blade 14.

Thereby, garbage mixed with various sizes can be crushed by a combination of the fixed crush blades and the rotating crush blades having small numbers of sheets.

Garbage crushed by cooperation of the third rotating crush blades 14 and the fourth fixed crush blade 15 is discharged from the slit 39 by cooperation of the respective arms 31 of the fourth fixed crush blade 15 and the fifth rotating crush blade 16.

That is, when garbage is brought into contact with the push face 33 of the arm 31 on the upper stage side by rotating the fifth rotating crush blade 16, by an angle of inclination of the push face 33, garbage is exerted with a force of being pushed downward constituting a direction of the fifth rotating crush blade 16.

Thereby, garbage is pushed to the slit 39 by the push face 33 by rotating the fifth rotating crush blade 16, crushed by the edge of the edge portion of the opening on the upper face side of the slit 39, further pushed to the push face 33 and is dropped downward by passing the slit 39.

As described above, the slit 39 is formed with the stepped portion 39a and the opening on the bottom face side is made to be larger than the opening on the upper face side. Therefore, garbage pushed to the slit 39 is moved to a portion having a wide width by passing the stepped portion 39a and is dropped downward without being clogged at the slit 39.

Now, according to the garbage disposer 1, for example, after driving to rotate the motor 6 by a constant period of time, the control means, not illustrated, stops driving the motor 6. A time period of driving the motor 6 is set in consideration of a time period necessary for crushing garbage of a standard amount taken into the hopper 3 to be discharged from the discharge pipe connecting port 8.

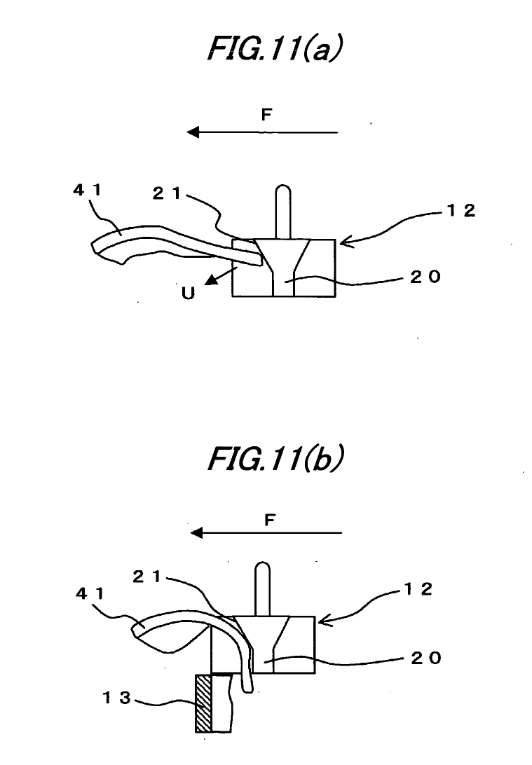

Next, operation of the first rotating crush blade 12 will be explained in details. FIG. 11(a) through FIG. 11(b) are operation explanatory views showing operation of taking in garbage by the first rotating crush blade 12. There are various sizes of garbage taken into the hopper 3 shown in FIG. 1 and the like before crushing operation. Comparatively light and large garbage of, for example, the skin of grapefruit or the like is frequently brought into a state of being mounted on the first rotating crush blade 12 or the second fixed crush blade 13 before crushing operation. When the respective rotating crush blades are rotated from the state and the first rotating crush blade 12 is rotated in, for example, an arrow mark F direction, as shown by FIG. 11(a), garbage 41 is butted to the push face 21 of the agitating arm 20.

The push face 21 is constituted by the inclined face inclined in the direction of projecting the upper end relative to the lower end and therefore, garbage 41 is exerted with a force of being pushed downward indicated by an arrow mark U by operating to rotate the first rotating crush plate 12 in the arrow mark F direction.

Thereby, as shown by FIG. 11(b), garbage 41 is pushed downward, crushed by cooperation of the first rotating crush blade 12 and the second fixed crush blade 13 and is further finely crushed by the crush blades at the lower stages.

Therefore, the performance of taking in garbage at an initial stage of crushing is promoted, the crushing processing can be finished in a predetermined processing time period and the crushing processing time period can be prevented from being prolonged. Here, by constituting the first rotating crush blade 12 by one piece of the agitating arm 20, a wide space is formed in the circumferential direction on the upper side of the crush unit 4 and the performance of taking in larger garbage is further promoted.

Further, according to the garbage disposer 1 of the example, the crush unit 4 is made to be attachable and detachable to and from the hopper 3, and can easily be attached and detached by holding the handle 18 of the housing 17. Further, when the crush unit 4 is attached to the hopper 3, the square hole portion 38b of the fifth rotating crush blade 16 needs to be fitted to the drive shaft 5a of the speed reducing unit 5. The drive shaft 5a and the square hole portion 38b are connected by fitting the square shaft and the square hole and therefore, a direction of the square hole portion 38b needs to be adjusted.

According to the example, the respective rotating crush blades are integrally rotated, the first crush blade 12 at the topmost stage includes the handle 20a and therefore, by holding and rotating the handle 20a, the fifth rotating crush blade 16 is rotated and the direction of the square hole portion 38b can be adjusted.

Therefore, the square hole portion 38b can be fitted to the drive shaft 5a of the speed reducing unit 5 by aligning the direction without directly touching portions of the rotating crush blades and the fixed crush blades, operability in attaching and detaching the blades is promoted and safety is promoted.

Further, by enabling to attach and detach the crush unit 4 easily to and from the hopper 3, the housing 17 and the respective crush blades can be cleaned by removing the crush unit 4 from the hopper 3.

### Embodiment 2

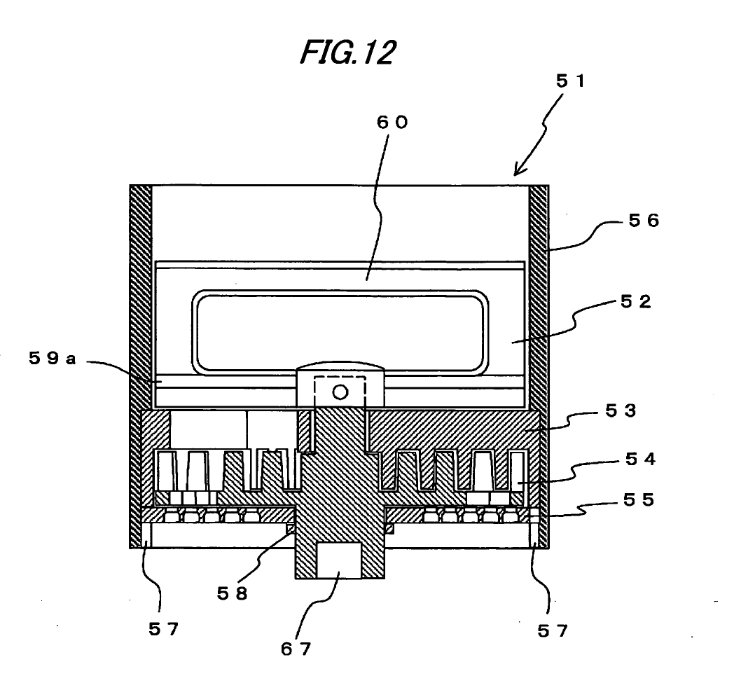

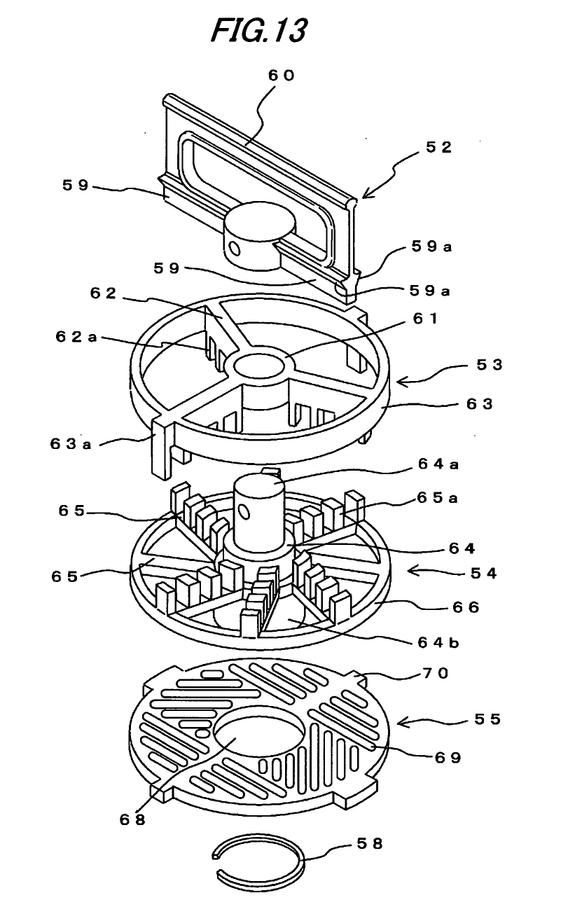

FIG. 12 and FIG. 13 show a crush blade of a garbage disposer according to one or more embodiments of the invention, FIG. 12 is a front sectional view of a crush unit 51, and FIG. 13 is a disassembled perspective view of an essential portion of the crush unit 51.

The crush unit 51 constitutes one unit by containing a first rotating crush blade 52, a second crush blade 53, a third rotating crush blade 54 and a fourth fixed crush blade 55 in a housing 56 as shown by FIG. 12.

The housing 56 is constituted by a cylindrical shape, and an outer diameter thereof is constituted to be substantially equal to an inner diameter of the hopper 3 shown in FIG. 2 and the like. The crush unit 51 is inserted from the take in opening portion 7 of the hopper 3, and the housing 56 is held by the inner peripheral face of the hopper 3.

Further, the housing 56 is provided with two pieces of the vertical grooves 57 at an interval of 180 degrees at the inner peripheral face. The second fixed crush blade 53 and the fourth fixed crush blade 55 are held in a state of being unable to rotate relative to the housing 56 by constituting shapes thereof engaged with the vertical grooves 57.

As shown by FIG. 13, the first rotating crush blade 52 includes two pieces of agitating arms 59 extended horizontally in a radial direction, and a handle 60 integrally formed with the agitating arm 59. According to the first rotating crush blade 52, the agitating arm 59 functions as a crush blade in cooperation with the second fixed crush blade 53, and the handle 60 functions as a handle in attaching and detaching the crush unit 51.

Further, the first rotating crush blade 52 is formed with push faces 59a at two front and rear faces in a direction of rotating the agitating arm 59. The push faces 59a are inclined faces inclined in directions of projecting upper ends relative to lower ends at the both side faces of the agitating arms 59.

By forming the push faces 59a at the both side faces of the agitating arm 59, the first rotating crush blade 52 can exert a force of pressing downward to garbage brought into contact with the push faces 59a by operating to rotate in two directions. Thereby, the first rotating crush blade 52 takes in garbage by the rotating operation to push to the crush blades at lower stages.

The second fixed crush blade 53 is constituted by a shape of surrounding 3 pieces of arms 62 extended radially from a hub 61 at intervals of 120 degrees by a ring 63. The respective arms 62 are formed with comb-like teeth portions 62a having a predetermined pitch at bottom faces thereof. Further, an outer periphery of the ring 63 is formed with tabs 63a projected in a radial direction at an interval of 180 degrees. The tabs 63a are fitted to the vertical grooves 57 of the housing 56 to restrict rotation of the second fixed crush blade 53.

The third rotating crush blade 54 is constituted by a shape of surrounding 8 pieces of arms 65 extended radially from a hub 64 in tangential line directions at equal intervals by a ring 66. Upper faces of 6 pieces of the arms 65 are formed comb-like teeth portions 65a in 8 pieces of the arms 65 by reason similar to that of the fourth fixed crush blade 15 shown in FIG. 9(a) through FIG. 9(c). The comb-like teeth portions 65a of the third rotating crush blade 54 are provided with a pitch brought in mesh with the comb-like teeth portions 62a of the second fixed crush blade 53, and when the second fixed crush blade 53 and the third rotating crush blade 54 are laminated, the comb-like teeth portions 62a, 65a of the both members are brought into a state of being brought in mesh with each other to form small gaps thereamong.

Thereby, the comb-like teeth portions 65a of the third rotating crush blade 54 crush garbage brought to between the arms 62 of the second fixed crush blade 53 in cooperation with the comb-like teeth portions 62a of the second fixed crush blade 53.

The hub 64 of the third rotating crush blade 54 includes a first shaft portion 64a on an upper side of a face of forming the arm 65 and includes a second shaft portion 64b on a lower side of the face of forming the arm 65. The first shaft portion 64a is rotatably fitted to the hub 61 of the second fixed crush blade 53. Further, a front end of the first shaft portion 64a is fixed with the first rotating crush blade 52.

The second shaft portion 64b is rotatably fitted with the fourth fixed crush blade 55. Further, the second shaft portion 64b is formed with a groove for fixing a C ring, not illustrated, and the fourth fixed crush blade 55 is held by the C ring 58.

Further, a bottom face of the second shaft portion 64b is formed with a square hole 67 for fitting the drive shaft 5a of the speed reducing unit 5 shown in FIG. 1. Although not illustrated, by fitting the square hole 67 of the second shaft portion 64b to the drive shaft 5a of the speed reducing unit 5, a drive force of the motor 6 is transmitted to the third rotating crush blade 54 and the third rotating crush blade 54 and the first rotating crush blade 52 are integrally rotated.

The fourth fixed crush blade 55 is constituted by a shape of a circular plate and arranged with a number of slits 69 at an entire face except a center circular hole 68 inserted rotatably with the second shaft portion 64b of the third rotating crush blade 54. The respective slits 69 are penetrated from head to tail of the fourth fixed crush blade 55. Garbage crushed by the comb-like teeth portion 62a of the second fixed crush blade 53 and the comb-like teeth portions 65a of the third rotating crush blade 54 and dropped to an upper face of the fourth fixed crush blade 55 is pressed to the slit 69 by rotating the third rotating crush blade 54 and is crushed by an edge portion of an opening edge portion on an upper face side of the slit 69. Further, the finely crushed garbage is dropped downward by passing the slit 69.

An outer periphery of the fourth rotating crush blade 55 is formed with tabs 70 projected in a radial direction at an interval of 180 degrees. The tab 70 is fitted to a vertical groove 57 of the housing 56 to restrict rotation of the fourth fixed crush blade 55.

Explaining an outline of operation of the garbage disposer including the crush unit 51 shown in FIG. 12 and FIG. 13, first, garbage is taken in by the first rotating crush blade 52 by rotating the respective rotating crush blades, grossly crushed garbage in cooperation with the first rotating crush blade 52 and the second fixed crush blade 53 is finely crushed by cooperation of the comb-like teeth portions 62a of the second fixed crush blade 53 and the comb-like teeth portions 65a of the fourth rotating crush blade 54. Further, garbage is crushed further finely to be discharged by cooperation of the arms 65 of the fourth rotating crush blade 54 and the slits 69 of the fifth fixed crush blade 55.

Even in the garbage disposer including the crush unit 51 shown in FIG. 12 and FIG. 13, by including the take in face 59a at the first rotating crush blade 52 at the topmost stage, a performance of taking in garbage at an initial stage of crushing is promoted.

### Embodiment 3

### <Total Constitution of Garbage Disposer>

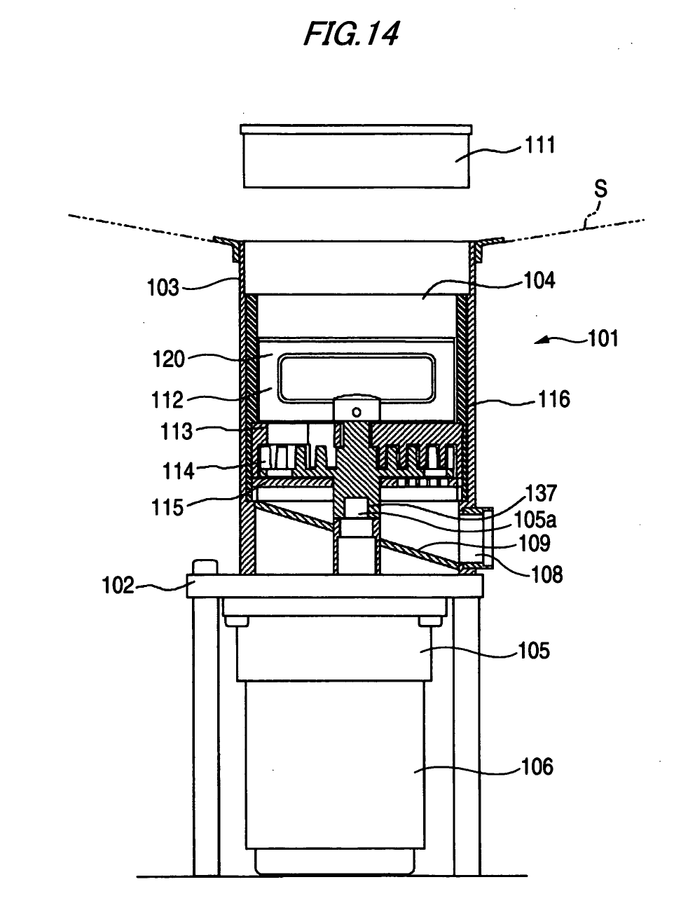

FIG. 14 is a front sectional view showing an outline of a constitution of the garbage disposer 101 according to one or more embodiments of the invention. The garbage disposer 101 is installed at, for example, a kitchen facility, mounted with the hopper 103 for taking in garbage or the like above the base frame 102 and an upper end of the hopper 103 is fitted to an opening portion of the kitchen sink S.

Inside of the hopper 103 is mounted with the crush unit 104 attachably and detachably to and from the hopper 103. According to the crush unit 104, a rotating crush blade, mentioned later, is fitted to the drive shaft 105a of the speed reducing unit 105, and the motor 106 attached to the base frame 102 drives to rotate the rotating crush blade of the crush unit 104 by way of the speed reducing unit 105. Although details are not illustrated, a portion of the drive shaft 105a for transmitting a drive force to the crush unit 104 fitted with the crush unit 104 is constituted by a square shaft.

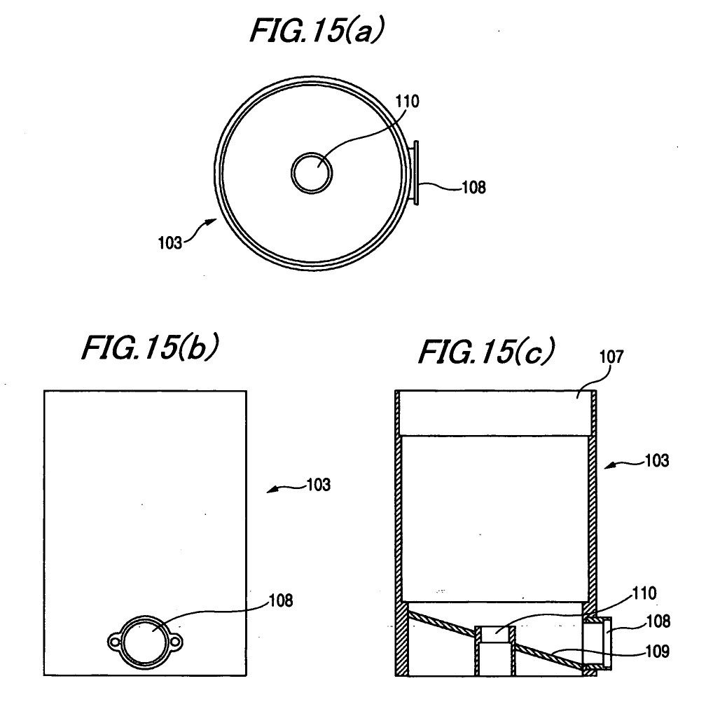

FIG. 15(a) through FIG. 15(c) show the hopper 103 constituting the garbage disposer 101, FIG. 15(a) is a plane view, FIG. 15(b) is a side view, FIG. 15(c) is a front sectional view. The hopper 103 is apart in a shape of an erected cylinder and is formed with the take in opening portion 107 at an upper end thereof. Further, the discharge pipe connecting port 108 is provided at a lower end of a peripheral face of the hopper 103. Further, inside of the hopper 103 is provided with the bottom plate 109 inclined to the discharge pipe connecting port 108, and a center of the bottom plate 109 is formed with the hole 110 for passing the drive shaft 105a of the speed reducing unit 105 shown in FIG. 1.

The lid member 111 shown in FIG. 14 is attached attachably and detachably to the take in opening portion 107 of the hopper 103. The lid member 111 is formed with a water supply hole, not illustrated, and is constituted to be able to supply water into the hopper 103 even when the take in opening portion 107 is closed by the lid member 111.

Further, when there is provided a detecting means for detecting that the take in opening portion 107 is closed by the lid member 111 by utilizing a permanent magnet, a magnet sensor and the like and control means, not illustrated, controls to drive the motor 106 or the like when it is detected that the take in opening portion 107 is closed by the lid member 111.

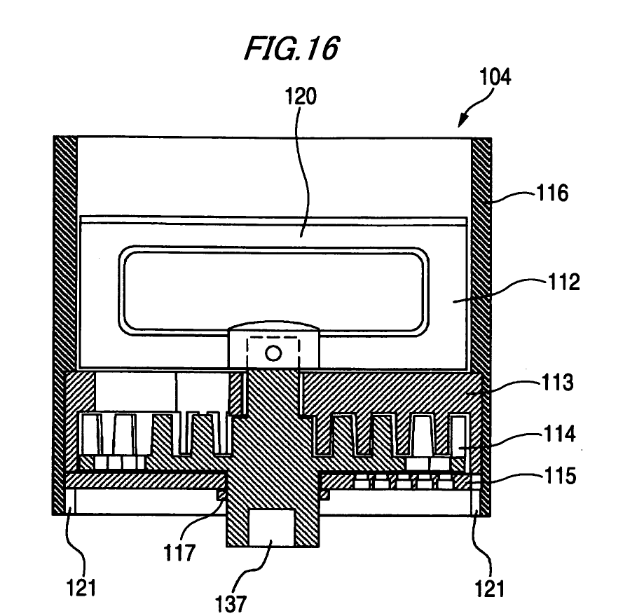

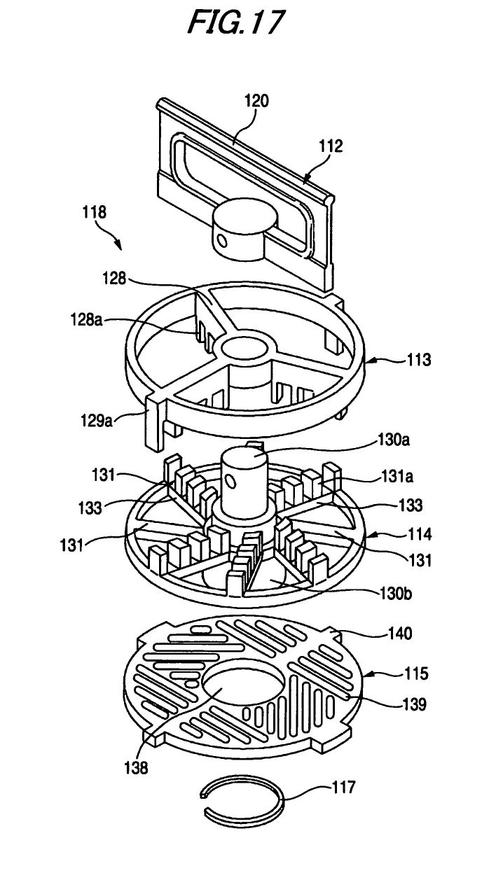

FIG. 16 and FIG. 17 show the crush unit 104 constituting the garbage disposer 101, FIG. 16 is a front sectional view of the crush unit 104, FIG. 17 is a disassembled perspective view of an essential portion of the crush unit 104.

The crush unit 104 constitutes one unit by containing the first rotating crush blade 112, the second fixed crush blade 113, the third rotating crush blade 114 and the fourth fixed crush blade 115 shown in FIG. 17 in the housing 116 as shown by FIG. 16.

Although details of constitutions of the respective crush blades will be described later, the second fixed crush blade 113 is interposed between the first rotating crush blade 112 and the third rotating crush blade 114 to be held, further, the fourth fixed crush blade 115 is held by fitting, for example, the C ring 117 to the shaft portion of the third rotating crush blade 114, and the crush blade unit 118 integrated with the respective crush blades is constituted. Further, the crush unit 104 is constituted by containing the crush blade unit 118 in the housing 116.

The housing 116 is constituted by a cylindrical shape, and an outer diameter thereof is constituted to be substantially equal to an inner diameter of the hopper 103 shown in FIG. 15 and the like. The crush unit 104 is inserted from the take in opening portion 107 of the hopper 103, and the crush unit 104 mounted to the hopper 103 constitutes a crush chamber by holding the housing 116 by the inner peripheral face of the hopper 103.

Here, the crush unit 104 is made to be able to be attached and detached to and from the hopper 103 by holding a handle 120 by providing the handle 120 to the first rotating crush blade 112.

As shown by FIG. 16, dimensions of the first rotating crush blade 112, the second fixed crush blade 113, the third rotating crush blade 114 and the fourth fixed crush blade 115 are set to be laminated in a state in which intervals in an up and down direction are hardly present to thereby prevent crushed garbage from being brought into the gaps of the crush blades in the up and down direction to remain at inside of the crush unit 104.

Further, although there is constructed a constitution in which the housing 116 is independent from the hopper 103, there may be constructed a constitution of integrally constituting the hopper 103 and the housing 116 and the crush blade unit 118 is attached and detached thereto and therefrom.

### <Constitution of Crush Unit>

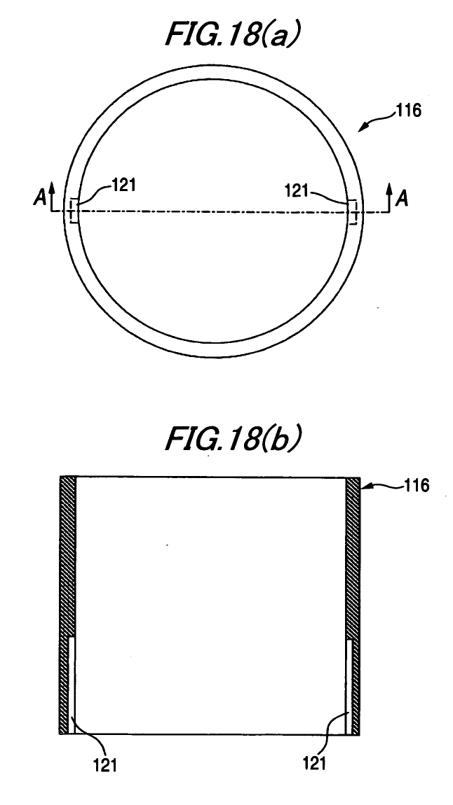

FIG. 18(a) through FIG. 23 show main constituent parts of the crush unit 104. FIG. 18(a) through FIG. 18(b) show the housing 116, FIG. 18(a) is a plane view, and FIG. 18(b) is a sectional view taken along a line A-A of FIG. 18(a).

The housing 116 is constituted by the cylindrical shape as described above, and provided with two pieces of the vertical grooves 121 at an interval of 180 degrees from a lower end to a middle in the up and down direction of the inner peripheral face. The second fixed crush blade 113 and the fourth fixed crush blade 115 are held in a state of being unable to rotate relative to the housing 116 by constituting shapes thereof engaging with the vertical grooves 121.

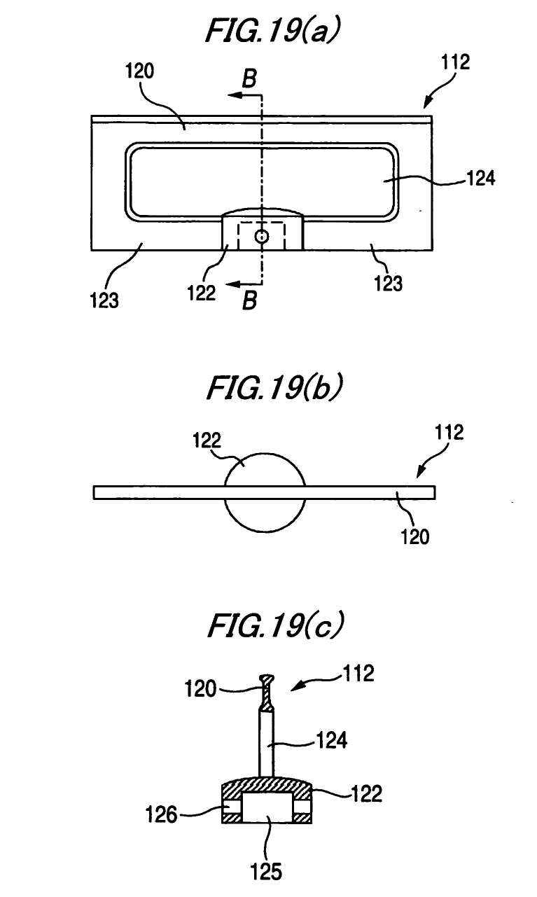

FIG. 19(a) through FIG. 19(c) show the first rotating crush blade 112 arranged at the topmost stage of the crush unit 104, FIG. 19(a) is a front view, FIG. 19(b) is a plane view, FIG. 19(c) is a sectional view taken along a line B-B of FIG. 19(a).

The first rotating crush blade 112 includes 2 pieces of the agitating arms 123 extended horizontally in a radial direction from a side portion of the bearing portion 122 at an interval of 180 degrees, and the handle 120 integrally formed with the agitating arm 123. The agitating arm 123 is constituted by a shape of a flat plate, formed with edges at lower end sides of the two side faces and functions as a crush blade in cooperation with the second fixed crush blade 113.

The handle 120 is formed with the opening portion 124. The first rotating crush blade 112 achieves light-weighted formation without reducing a strength thereof by forming an upper end of the handle 120 and an edge portion of the opening portion 124 of the handle 120 by thick walls and forming the portion of the handle 120 by a thin wall.

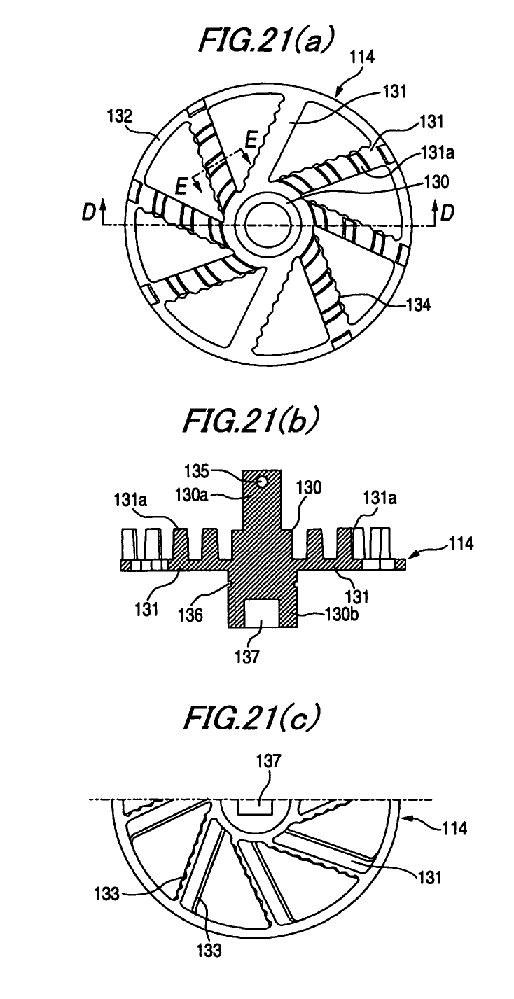

The bearing portion 122 is formed with the shaft attaching hole 125 on a bottom face side thereof and is formed with the fixing hole 126 attached with a screw, not illustrated, by penetrating the shaft attaching hole 125. The bearing portion of the first rotating crush blade 112 is fixed to a shaft portion, mentioned later, of the third rotating crush blade 114 shown in FIG. 21(a) through FIG. 21(c), and the first rotating crush blade 112 and the third rotating crush blade 114 are integrally rotated.

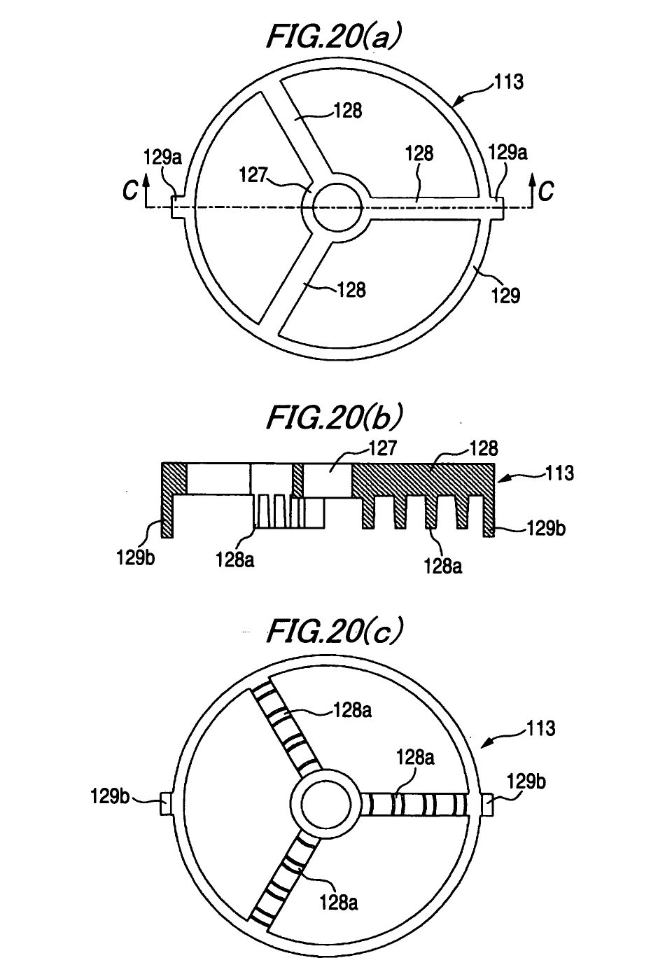

FIG. 20(a) through FIG. 20(c) show the second fixed crush blade 113 arranged at a lower stage of first rotating crush blade 112, FIG. 20(a) is a plane view, FIG. 20(b) is a sectional view taken along a line C-C of FIG. 20(a), FIG. 20(c) is a bottom view.

The second fixed crush blade 113 is constituted by a shape of surrounding 3 pieces of the arms 128 extended radially from the hub 127 by the ring 129 at an interval of 120°. The respective arms 128 are formed with the comb-like teeth portions 128a having a predetermined pitch at bottom faces thereof. Further, an outer diameter of the ring 129 is substantially the same as an inner diameter of the housing 116 shown in FIG. 19(a) through FIG. 19(b) and an outer periphery of the ring 129 is formed with the tabs 129a projected in a radial direction by an interval of 180 degrees. The tab 129a is fitted to the vertical groove 121 of the housing 116 to restrict rotation of the second fixed crush blade 113.

Further, the tab 129a is formed with the leg portion 129b to thereby form a gap of a predetermined height between the second fixed crush blade 113 and the fourth fixed crush blade 115. Further, an inner diameter of the hub 127 is larger than a diameter of a shaft portion, mentioned later, of the third rotating crush blade 114 shown in FIG. 21(a) through FIG. 21(c) to constitute a dimension of not interfering with the shaft portion of the third rotating crush blade 114.

FIG. 21(a) through FIG. 21(c) show the third rotating crush blade 114 arranged at a lower stage of the second fixed crush blade 113, FIG. 21(a) is a plane view, FIG. 21(b) is a sectional view taken along a line D-D of FIG. 21(a), FIG. 21(c) is bottom view omitting one side half thereof.

The third rotating crush blade 114 is constituted by a shape of surrounding 8 pieces of the arms 131 extended radially from the hub 130 in tangential line directions at equal intervals by the ring 132. The comb-like teeth portions 131a are formed at upper faces of 6 pieces of the arm 131 in 8 pieces of the arms 131. The comb-like teeth portion 131a of the third rotating crush blade 114 is provided with a pitch of being brought in mesh with the comb-like teeth portion 128a of the second fixed crush blade 113 shown in FIG. 20(a) through FIG. 20(c), and when the second fixed crush blade 113 and the third rotating crush blade 114 are laminated as shown by FIG. 16, the comb-like crush portions 128a, 131a of the both members are brought into a state of being brought in mesh with each other to form small gaps thereamong.

The comb-like teeth portion 131a of the third rotating crush blade 114 crushes garbage brought to between the arms 128 of the second fixed crush blade 113 shown in FIG. 20(a) through FIG. 20(c) in cooperation with the comb-like teeth portion 128a of the second fixed crush blade 113.

As described above, there are 3 pieces of the arm 128 of the second fixed crush blade 113 and 8 pieces of the arm 131 of the third rotating crush blade 114 and therefore, an interval between the arms 131 is narrower than an interval between the arms 128.

Therefore, when the comb-like teeth portions 131a are provided for all of 8 pieces of the arms 131, there is brought about a state in which the comb-like teeth portion 131a of the third fixed crush blade 114 is always present between the arms 128 of the second fixed crush blade 113, and when garbage in a block shape having some degree of size is taken in, there is brought about a phenomenon in which garbage is not taken in between the arms 128 of the second fixed crush blade 113 and is difficult to be crushed.

Hence, in the third rotating crush blade 114, by not providing the comb-like teeth portions 131a at, for example, 2 pieces of the arms 131 in 8 pieces of the arms 131, in operating to rotate the third rotating crush blade 114, when the arm 131 which is not provided with the comb-like teeth portion 131a is disposed between the arms 128 of the second fixed crush blade 113, a wide space is made to be formed in a circumferential direction.

Thereby, even when garbage in the block shape having some degree of size is taken in, garbage is brought to between the arms 128 of the second fixed crush blade 113, and garbage is crushed by cooperation of the comb-like teeth portion 131a of the other arm 131 and the comb-like teeth portion 128a of the second fixed crush blade 113 by operating to rotate the third rotating crush blade 114.

Further, when a number of the arms 131 which are not provided with the comb-like teeth portions 131a in the third rotating crush blade 114 is large, a crush function is reduced and therefore, when, for example, 8 pieces of the arms 131 are provided, it is preferable to provide about 2 pieces of the arms 131 which are not provided with the comb-like teeth portions 131a.

Here, the arms 131 which are not provided with the comb-like teeth portions 131a are brought into a positional relationship of 180 degrees to thereby prevent nonuniformity in rotation or vibration by taking a balance in rotating the third rotating crush blade 114.

Further, by extending the respective arms 131 radially along the tangential line directions of the hubs 130, in rotating the third rotating crush blade 114, a peak of a crush load is restrained and the load is flattened by shifting a point of being brought in mesh with the second fixed crush blade 113 in the circumferential direction.

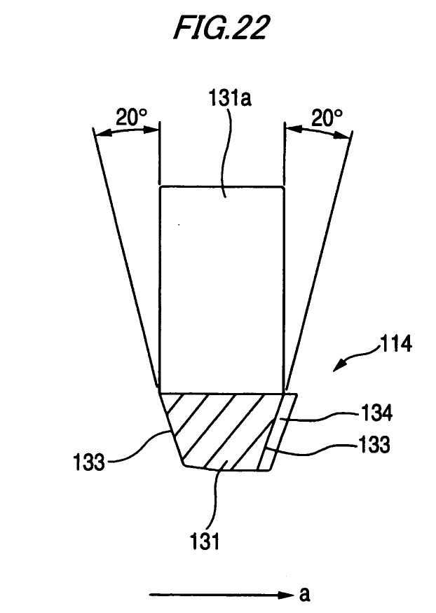

The third rotating crush blade 114 is formed with the push faces 133 at two front and rear faces in a rotational direction of the respective arms 131. FIG. 22 is a sectional view taken along a line E-E of FIG. 21(a) showing details of the push faces 133.

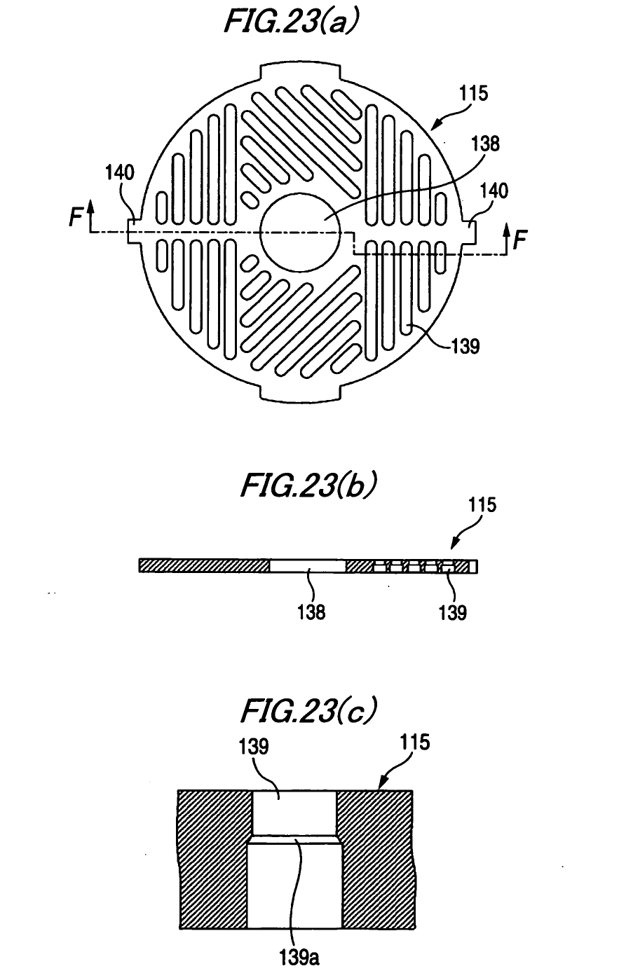

The push faces 133 are inclined faces (taper faces) inclined in directions of projecting upper ends relative to lower ends at two side faces of the arm 131. The third rotating crush blade 114 is operated to rotate while rubbing the bottom face of the arm 131 to the fourth fixed crush blade 115 shown in FIG. 23(a) through FIG. 23(c), by forming the push faces 133 at the two side faces of the arm 131, garbage (crushed to some degree of size) brought into contact with the push face 133 can be exerted with a force of being pushed to the fourth fixed crush blade 115.

According to the example, an angle of inclination of the push face 133 is set to 20 degrees relative to a vertical face. When the angle of inclination of the push face 133 is small (near to vertical face), a force of pushing garbage is weakened. Further, when the angle of inclination of the push face 133 is large, garbage having a thin thickness is made to be easy to be taken in to between the bottom face of the arm 131 and the fourth fixed crush blade 115.

Therefore, it is preferable that the angle of inclination of the push face 133 falls in a range of about 10 degrees through 30 degrees relative to vertical face, further specifically, the angle of inclination of around 20 degrees is preferable.

Referring back to FIG. 21(a) through FIG. 21(c), one side face of the each arm 131 is formed with the wavy face 134 aligned with vertical grooves. Thereby, in operating to rotate the third rotating crush blade 114 in one direction, garbage is caught by a recess portion of the wavy face 134 to restrain garbage from moving in a radius direction and garbage is made to be able to be crushed firmly. Here, also the wavy face 134 is inclined in the up and down direction as shown by FIG. 22 to form the push face 133.

Further, by forming the wavy face 134 at one side of each arm 131 in the third rotating crush blade 114, when the third rotating crush blade 114 is rotated in a direction of constituting a front face in the rotational direction by the wavy face 134, there is mainly carried out operation of further finely crushing garbage crushed to some degree of size by the comb-like teeth or the like at the upper stage by cooperation of the wavy face 134 and the push face 133 and the fourth fixed crush blade 115 shown in FIG. 23(a) through FIG. 23(c). In contrast thereto, in rotating the third rotating crush blade 114 in an inverse direction, there is mainly carried out operation of discharging garbage by cooperation of the push face 133 and the fourth fixed crush blade 115 shown in FIG. 23(a) through FIG. 23(c).

The hub 130 of the third rotating crush blade 114 includes the first shaft portion 130a on an upper side of a face of forming the arm 131 and includes the second shaft portion 130b on a lower side of the face of forming the arm 131. The first shaft portion 130a is rotatably fitted to the hub 127 of the second fixed crush blade 113 shown in FIG. 20(b). Further, a front end of the first shaft portion 130a is fitted to the shaft attaching hole 125 of the bearing portion 122 of the first rotating crush blade 112 shown in FIG. 19(a) through FIG. 19(c).

The first shaft portion 130a is formed with the fixing hole 135 communicating with the fixing hole 126 of the bearing portion 122 when fitted to the bearing portion 122 of the first rotating crush blade 112 and the first rotating crush blade 112 is fixed to the third rotating crush blade 114 by fastening the fixing hole 126 of the bearing portion 122 and the fixing hole 135 of the first shaft portion 130a by a screw, not illustrated.

The second shaft portion 130b is rotatably fitted with the fourth fixed crush blade 115 shown in FIG. 23(a) through FIG. 23(c). Further, the second shaft portion 130b is formed with the groove 136 for fixing a C ring and the fourth fixed crush blade 115 is held by the C ring 117 as shown by FIG. 16.

Further, a bottom face of the second shaft portion 130b is formed with the square hole 137 for fitting the drive shaft 105a of the speed reducing unit 105 shown in FIG. 14. As shown by FIG. 14, by fitting the square hole 137 of the second shaft portion 130b to the drive shaft 105a of the speed reducing unit 105, a drive force of the motor 106 is transmitted to the third rotating crush blade 114, and the third rotating crush blade 114 and the first rotating crush blade 112 are integrally rotated.

Now, the respective crush blades are integrally formed products of metal, for example, in the case of the third rotating crush blade 114, there is carried out operation of forming an edge by cutting a bottom face after forming in order to form a sharp edge at a boundary between the push face 133 and the bottom face of the arm 131.

In the case of the third rotating crush blade 114, cutting is carried out by rotating the third rotating crush blade 114 in a direction indicated by an arrow mark a in FIG. 22 relative to a cutting member of a file or the like. Thereby, a sharp edge is formed at the boundary between the push face 133 and the bottom face of the arm 131 on a side of forming the wavy face 134 constituting a front end side in the cutting direction.

However, burr is produced on a rear end side in the cutting direction. Therefore, by forming an inclined face for escaping burr in forming at one face side of the bottom face of the arm 131, the burr is prevented from being produced at the boundary of the push face 133 and the bottom face to thereby prevent the crush function from being reduced. Therefore, depending on a method of fabricating the third rotating crush blade 114, the bottom face of the arm 131 may be constituted by a plane.

FIG. 23(a) through FIG. 23(c) show the fourth fixed crush blade 115 arranged at a lower stage of the third rotating crush blade 114, FIG. 23(a) is a plane view, FIG. 23(b) is a sectional view taken along a line F-F of FIG. 23(a), FIG. 23(c) is a sectional view enlarging an essential portion.

The fourth fixed crush blade 115 is constituted by a shape of a circular plate and aligned with a number of the slits 139 over an entire face thereof except the hub 138 at a center. Further, the fourth fixed crush blade 115 of the example is formed with a plurality of slit groups and in the respective slit groups, the slits 139 contiguous to each other are aligned in parallel.

An upper face of the fourth fixed crush blade 115 is constituted by a plane and is rotated while being brought into contact with the bottom faces of the respective arms 131 of the third rotating crush blade 114 shown in FIG. 21(a) through FIG. 21(c). Further, the slit 139 shown in FIG. 23(a) through FIG. 23(c) is penetrated from head to tail of the fourth fixed crush blade 115 and a sharp edges are formed on an upper face side of the slit 139 opposed to the third rotating crush blade 114.

Garbage crushed by the comb-like teeth portions 128a of the second fixed crush blade 113 shown in FIG. 20(a) through FIG. 20(c) and the comb-like teeth portions 131a of the third rotating crush blade 114 shown in FIG. 21(a) through FIG. 21(c) and is dropped to the upper face of the fourth fixed crush blade 115 is caught by the slit 139, pushed to the slit 139 by the push face 133 by rotating the third rotating crush blade 114 and is crushed by the edge portion of the slit 139. Further, finely crushed garbage is dropped downward by passing the slit 139 and is discharged to outside from the discharge pipe connecting port 108 by passing the bottom plate 109 of the hopper 103 shown in FIG. 2.

Now, as shown by FIG. 23(c), the slit 139 is formed with the stepped portion 139a, an opening on a bottom face side is made to be larger than an opening on an upper face side to thereby facilitate to drop garbage pushed into the slit 139. Thereby, garbage pushed into the slit 139 by the push face 133 of the third crush blade 114 is facilitated to drop downward.

An outer periphery of the fourth rotating crush blade 115 is formed with the tabs 140 projected in a radial direction at an interval of 180 degrees. The tab 140 is fitted to the vertical groove 121 of the housing 116 shown in FIG. 5 to restrict rotation of the fourth fixed crush blade 115.

Further, in arranging the slits 139, the slits 139 may be aligned in a direction normal to the hub 138 or aligned in a tangential line direction thereof, although not illustrated, other than the example shown in FIG. 23(a) through FIG. 23(c). Further, the slit 139 may be aligned in a shape of an involute curve.

### <Operation of Garbage Disposer>

Next, an explanation will be given of operation of the garbage disposer 101 shown in FIG. 14. First, explaining operation of a total of the garbage disposer 101 in reference to the respective drawings, when garbage is taken in from the take in opening portion 107 and the take in opening portion 107 is closed by the lid member 111, for example, control means rotates the motor 106 by detecting that the take in opening portion 107 is closed by the lid member 111. Specifically, there is carried out rotating operation of repeating regular rotation and reverse rotation operation at every several seconds, for example, at every 5 seconds. A rotational speed of the motor 106 is set to about 100 rpm to restrain noise or vibration from being brought about.

Further, the lid member 111 is formed with a water supply hole, not illustrated, to construct a constitution of capable of supplying water into the hopper 103 even when the take in opening portion 107 is closed by the lid member 111, and water is supplied to inside of the hopper 103 by making water flow at the sink S in processing to crush garbage.

When the motor 106 is rotated, in the crush unit 104, the first rotating crush blade 112 and the third rotating crush blade 114 are integrally rotated. In contrast thereto, the second fixed crush blade 113 and the fourth fixed crush blade 115 are not rotated.

Thereby, garbage taken in to the hopper 103 from the take in opening portion 107 is agitated by the agitating arm 123 of the first rotating crush blade 112, garbage is grossly crushed by cooperation by the arm 128 of the second fixed crush blade 113 at the lower stage, and crushed garbage is brought to between the arms 128 of the second fixed crush blade 113.

Garbage brought to between the arms 128 of the second fixed crush blade 113 is finely crushed by bringing the comb-like teeth portion 128a of the arm 128 of the second fixed crush blade 113 and the comb-like teeth portion 131a of the arm 131 of the third rotating crush blade 114 in mesh with each other by rotating the third rotating crush blade 114 at the lower stage.

Here, in the third rotating crush blade 114, by providing the arm 131 which is not provided with the comb-like teeth portion 131a in a plurality of the arms 131, when the arm 131 which is not provided with the comb-like teeth portion 131a is disposed between the arms 128 of the second fixed crush blade 113 by rotating the third rotating crush blade 114, the large space is formed in the circumferential direction. Thereby, even large garbage in a block shape or the like is brought to between the arms 128 of the second fixed crush blade 113 and is finely crushed by bringing the comb-like teeth portion 128a of the second fixed crush blade 113 and the comb-like teeth portion 131a of the arm of the other arm 131 of the third rotating crush blade 114 in mesh with each other by rotating the third rotating crush blade 114.

Thereby, by a combination of the fixed crush blades and the rotating crush blades having small numbers of sheets, garbage mixed with various sizes can be crushed.

Garbage crushed by cooperation of the second fixed crush blades 113 and the third rotating crush blade 114 is discharged from the slit 139 by cooperation of the respective arms 131 of the third rotating crush blade 114 and the fourth fixed crush blade 115.

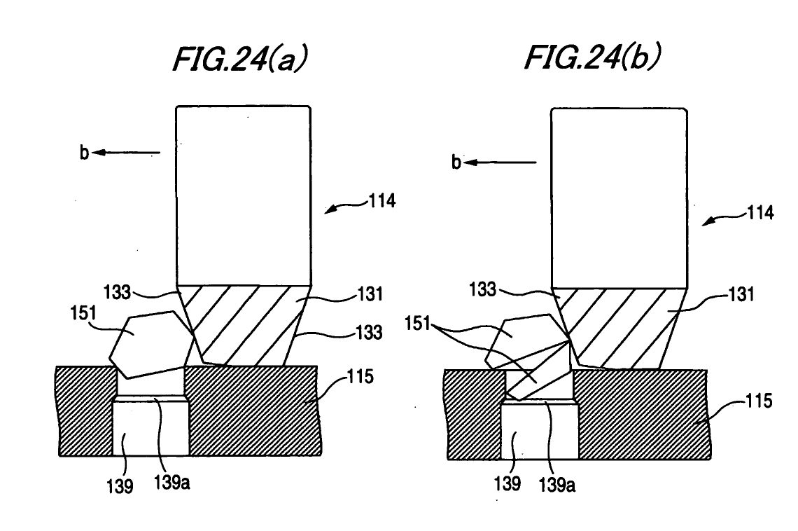

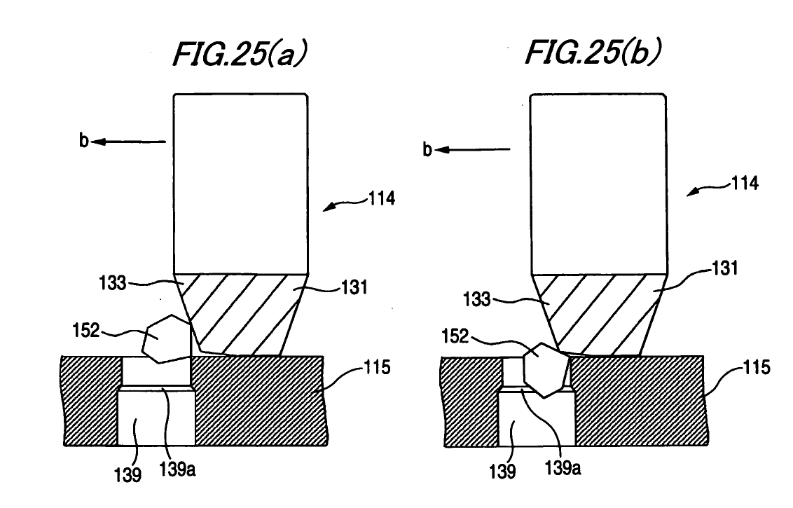

Next, an explanation will be given of details of operation of the third rotating crush blades 114 and the fourth fixed crush blade 115. FIG. 24(a) through FIG. 25(b) are sectional views showing crushing and discharging operation by the third rotating crush blade 114 and the fourth fixed crush blade 115.

FIG. 24(a) through FIG. 24(b) show a state of dropping garbage 151 larger than the width of the slit 139 onto the fourth fixed crush blade 115. When the third rotating crush blade 114 is rotated in, for example, arrow mark b direction and the push face 133 of the arm 131 is brought into contact with garbage 151, by the angle of inclination of the push face 133, garbage 151 is exerted with a force of being pushed downward constituting the direction of the fourth fixed crush blade 115.

Thereby, garbage 151 is pushed to the slit 139 by the push face 133 by rotating the third rotating crush blade 114, crushed by the edge of the slit 139, pushed further by the push face 133 and is dropped downward by passing the slit 139.

As described above, the slit 139 is formed with the stepped portion 139a and the opening on the bottom side of is made to be larger than the opening on the upper face side. Therefore, even when garbage 151 pushed to the slit 139 by the push face 133 of the third rotating crush blade 114 to be crushed is provided with a size the same as the width of the slit 139, garbage 151 is moved to a portion having a wider width by passing the stepped portion 139a by being further pushed by the push face 133 and is dropped downward without clogging the slit 139.

FIG. 25(a) through FIG. 25(b) show a state of dropping garbage 152 equivalent to or smaller than the width of the slit 139 onto the fourth fixed crush blade 115. When the third rotating crush blade 114 is rotated in, for example, arrow mark b direction and the push face 133 of the arm 131 is brought into contact with garbage 152, by the angle of inclination of the push blade 133, garbage 152 is pushed to the slit 139 by the push face 133.

According to the slit 139, the opening on the bottom face side is made to be larger than the opening on the upper face side and therefore, even garbage 152 having a size the same as the width of the slit 139 is pushed by the push face 133 and is dropped downward without clogging the slit 139 by passing the stepped portion 139a.

Further, also by pushing successive garbage, garbage 152 is pushed to a portion having a wide width from a portion having a narrow width by passing the stepped portion 139a and is dropped without clogging the slit 139.

Thereby, crushed garbage on the fourth fixed crushed blade 115 is positively dropped downward from the slit 139 and garbage can be prevented from being stagnated on the fourth fixed crush blade 115.

As explained in reference to FIG. 22, when the angle of inclination of the push face 133 is small, the force of pushing the garbage to the slit 139 is weakened and garbage cannot sufficiently be crushed or discharged. Further, when the angle of inclination of the push face 133 is large, garbage having a thin thickness (vegetable waste having much leaves or the like) is facilitated to be bitten between the bottom face of the arm 131 and the fourth fixed crush blade 115 and is not sufficiently crushed or discharged invariably. Therefore, as the angle of inclination of the crush blade 133, an angle of inclination around 20 degrees is preferable relative to the vertical face.

Here, by forming the push faces 133 at the both side faces of the arm 131, an area of bringing the respective arms 131 and the fourth fixed crush blade 115 into contact with each other is narrowed. Thereby, abrasion sound between metals in the rotating operation can be reduced.

Further, although an explanation has been given by taking an example of the case of rotating the third rotating crush blade 114 in the arrow mark b direction in FIG. 24(a) through FIG. 25(b), the push faces 133 are formed at the two side faces of the arm 131 and the third rotating crush blade 114 is driven to rotate into two regular and inverse directions and therefore, even when rotated in a direction reverse to that of FIG. 24(a) through FIG. 25(b), an equivalent effect can be achieved.

Now, according to the garbage disposer 101, for example, after driving to rotate the motor 106 by a constant period of time, the control means, not illustrated, stops driving the motor 106. A time period of driving the motor 106 is set in consideration of a time period necessary for crushing garbage of a standard amount taken into the hopper 103 to be discharged from the discharge pipe connecting port 108.

According to the garbage disposer 101 of the example, the crush unit 104 can be attached and detached to and from the hopper 103 and can easily be attached thereto and detached therefrom by holding the handle 120 of the first rotating crush blade 112. By integrally constituting the handle 120 to the crush blade in this way, it is not necessary to separately provide the handle and a number of parts can be reduced, space can effectively be utilized.

Further, in attaching the crush unit 104 to the hopper 103, it is necessary to fit the second shaft portion 130b of the third rotating crush blade 114 to the drive shaft 105a of the speed of reducing unit 105. The drive shaft 105a and the second shaft portion 130b are connected by fitting the square shaft and the square hole and therefore, a direction of the second shaft portion 130b needs to be adjusted.

According to the example, the third rotating crush blade 114 including the second shaft portion 130b is integrally connected with the first rotating crush blade 112 including the handle 120 and therefore, by rotating by holding the handle 120, also the third rotating crush blade 114 is rotated and the direction of the second shaft portion 130b can be adjusted.

Therefore, the direction of the square hole 137 of the second shaft portion 130b can be aligned to be fitted to the drive shaft 105a of the speed reducing unit 105 without directly touching portions of blades of the rotating crush blades and the fixed crush blades, operability in attachment and detachment is promoted and safety is promoted.

Further, by enabling to attach and detach the crush unit 104 easily to and from the hopper 103, the housing 116 and the respective crush blades can be cleaned by removing the crush unit 104 from the hopper 103. Further, the respective crush blades can also be cleaned by removing the crush blade unit 118 from the housing 116.

Although an explanation has been given of the invention in details and in reference to the specific embodiments, it is apparent for the skilled person that the invention can variously be changed or modified without deviating the spirit and the range of the invention.

The application is based on Japanese Patent Application (Japanese Patent Application No. 2004-194745) filed on Jun. 30, 2004 and Japanese Patent Application (Japanese Patent Application No. 2004-197324) filed on Jul. 2, 2004 and the contents of which are incorporated herein by reference.

### INDUSTRIAL APPLICABILITY

According to one or more embodiments of the invention, by pushing garbage to the push plate by operating to rotate the rotating crush blade and the fixed crush blade relative to each other, garbage is exerted with the force of being pushed downward and is pushed to the crush blade at the lower stage. Thereby, garbage can firmly be taken in by the rotating crush blade or the fixed crush blade arranged at the topmost stage in the laminating direction, and also a performance of taking in comparatively light and large garbage or the like is promoted.

Therefore, the crushing processing can be finished within a predetermined processing time period and the crush processing time period can be prevented from being prolonged.

Further, according to one or one or more of the embodiments of the invention, the crush unit alternately laminated with the rotating crush blades and the fixed crush blades is made to be able to be attached and detached to and from the hopper, and the handle is formed at the rotating crush blade or the crush blade arranged at the topmost stage of the crush unit and therefore, the handle can be provided by utilizing the space necessary for containing the rotating crush blade or the fixed crush blade in the background art, and the handle having a size in consideration of operability can be provided without sacrificing a processing volume.

Further, it is not necessary to provide the handle by a separate member and therefore, a number of parts can be reduced and a reduction in cost can be achieved.

Further, when there is constructed a constitution of providing the handle at the rotating crush blade, particularly in attaching the crush unit, the direction of the rotating crush blade can be adjusted by the handle and attachment and detachment operability is promoted.

The invention is installed at a kitchen or the like of a building and can promote convenience of processing garbage.

Further, the invention is installed at a kitchen or the like of a building and can promote convenience of processing garbage.

1. A garbage disposer comprising:
at least one rotating crush blade;
at least one fixed crush blade alternately laminated with the rotating crush blade; and
a push face formed to be inclined on at least a portion of front and rear faces or a front face in a direction of rotating the rotating crush blade of the rotating crush blade or the fixed crush blade arranged on a topmost stage in a direction of laminating the rotating crush blade and the fixed crush blade.

2. The garbage disposer according to claim 1, wherein a garbage is crushed and discharged downward by the rotating crush blade and the fixed crush blade by driving to rotate the rotating crush blade, and the push face pushes the garbage downward.

3. The garbage disposer according to claim 1, further comprising:
at least one agitating arm provided on the rotating crush blade or the fixed crush blade formed with the push face and extended from a rotational center to an outer periphery;
wherein the push face is formed on the agitating arm.

4. The garbage disposer according to claim 1, wherein the push face is formed on the rotating crush blade, and
the rotating crush blade is formed with a handle for adjusting a direction of a direction of rotating the respective rotating crush blades.

5. The garbage disposer according to claim 3, wherein the push face is formed on the rotating crush blade, and
the rotating crush blade is formed with a handle for adjusting a direction of a direction of rotating the respective rotating crush blades.

6. A garbage disposer comprising:
a hopper;
a crush unit including at least one rotating crush blade and at least one fixed crush blade alternately laminated with the rotating crush blade and attachable and detachable to and from the hopper; and
a handle formed on the rotating crush blade or the fixed crush blade arranged on a topmost stage of the crush unit.

7. The garbage disposer according to claim 6, wherein the topmost stage of the crush unit is arranged with the rotating crush blade, and the handle is formed on the rotating crush blade at the topmost stage.

8. The garbage disposer according to claim 7, wherein in the rotating crush blade formed with the handle, a crush blade for crushing an object to be crushed in cooperation with the fixed crush blade arranged at a lower stage thereof is integrally formed with the handle.
